(19) United States
(12) Patent Application Publication
(10) Pub. No.: US 2019/0308905 A1
(43) Pub. Date: Oct. 10, 2019

(54) NANOCOMPOSITES WITH INTERLOCKING NANOSTRUCTURES

(71) Applicant: Wichita State University, Wichita, KS (US)

(72) Inventor: Davood Askari, Wichita, KS (US)

(21) Appl. No.: 16/146,839

(22) Filed: Sep. 28, 2018

Related U.S. Application Data
(60) Provisional application No. 62/654,806, filed on Apr. 9, 2018.
(60) Provisional application No. 62/675,585, filed on May 23, 2018.

(51) Int. Cl. C03C 25/44; C01B 32/16; C01B 32/168; C08J 5/00; C03C 13/00; C03C 25/223

(52) U.S. Cl. CPC C03C 25/44; C01B 32/16; C01B 32/168; B82Y 30/00; C03C 13/00; C03C 25/223; C08J 5/005

(57) ABSTRACT

Reinforced nanocomposite structures are described herein. Nanocomposite structures containing reinforcement fibers that are mechanically interlocked together with nanostructures are also described. Helical carbon nanotubes can be used to create high-performance multifunctional nanocomposite materials systems. Nanocomposite materials systems described also include chemically functionalized nanomaterials that are highly bent, kinked, twisted, entangled and mechanically interlocked within a resin system and/or traditional microfiber reinforcements.

### CLAIM OF PRIORITY

This application claims the benefit of U.S. Provisional Patent Application Ser. No. 62/564,806, filed on Sep. 28, 2017, and U.S. Provisional Patent Application Ser. No. 62/675,585, filed on May 23, 2018, the entire contents of each are hereby incorporated by reference.

### TECHNICAL FIELD

This document relates to reinforced nanocomposite structures. In particular, this document relates to nanocomposite structures containing reinforcement fibers that are mechanically interlocked together with nanostructures.

### BACKGROUND

There is increasing demand for high-performance materials with desired properties and multifunctional capabilities for a wide range of applications. For example, there is a need for new materials system with improved properties, multifunctionality, and performance for a broader range of applications (e.g., space and aerospace structures, electronic and biomedical devices and sensors, energy and materials storage, sporting goods, gears, and automotive industry, to provide a few examples).

Structural composites often contain reinforcements, such as laminated layers, which are bonded together by a matrix substrate. The matrix substrate often dominates interlaminar and transverse (i.e., through-the-thickness and between layers) properties of the structural composites because the matrix alone bonds the laminated layers together. Structural composites can be associated with poor interlaminar and transverse properties within the composite that can lead to interlaminar failures, such as delamination, because the matrix substrate lacks the desired strength for many high-performance applications. Traditional structural composites also tend to have weak through-the-thickness properties. In addition, when laminated composite parts are manufactured using unidirectional and/or 2-D woven fabric reinforcement, the interlaminar and through-the-thickness properties are controlled by the weak matrix, since the adjacent layers and fibers are bonded by the matrix only, yielding poor interlaminar and through-the-thickness properties. This weakness often leads to interlaminar failures (such as delamination) in composites.

To overcome these problems, three-dimensional (3D) composites, such as 3D stitching and 3D braiding, have been proposed to include microscale structures (e.g., Z-pinning) that extend transversely through the composites. However, these do not solve issues relating to general purpose application because the thickness properties should ideally be known in advance, but materials properties are compromised in planar direction. Further, such proposed 3D composites can be difficult to control dimensionally (e.g., thickness), may not compromise desired properties of the laminated layers within the composite, or can lack multi-functionality characteristics that are desirable in various composite applications.

### SUMMARY

Disclosed herein are various embodiments of reinforced nanocomposite structures. In particular, this document relates to nanocomposite structures containing reinforcement fibers that are mechanically interlocked together with nanostructures. In some embodiments, the nanostructures can be chemically functionalized.

In some aspects, a nanocomposite structure can comprise: a first microfiber; a second microfiber; and a plurality of nanostructures coupling the first and second microfibers together, and the plurality of nanostructures comprise helical tubes. In some embodiments, plurality of nanostructures comprises chemically functionalized nanostructures. In some embodiments, the helical tubes can be selected from the group consisting of helical carbon tubes, chemically functionalized helical carbon tubes, and combinations thereof.

In some embodiments, at least a portion of the plurality of nanostructures can couple with the first fiber and adjacent nanostructures. In some embodiments, the nanostructures can be selected from the group consisting of carbon, boron nitride, silicon, silicon carbide, silver-gallium, platinum, silver, metal oxides, and combinations thereof. In some embodiments, the nanostructures comprise carbon. In some embodiments, the first microfiber, the second microfiber, or both, can be selected from the group consisting of glass, a para-aramid synthetic fiber, carbon, silicon carbide, boron, aluminum oxide, or combinations thereof. In some embodiments, the nanostructures can have an elongate body with a length of greater than 2 microns. In some embodiments, the nanostructures can have an elongate body with a length ranging from about 10 microns to about 50 microns, from about 50 microns to about 100 microns, from about 100 microns to about 500 microns, from about 500 microns to about 1000 microns, or from about 1000 microns to about 10000 microns.

The amount of nanostructures can range from about 0.02% to about 1% by weight of the nanocomposite. The amount of the nanostructures can be less than 1% by weight of the nanocomposite. In some embodiments, the amount of the nanostructures can be less than 0.5% by weight of the nanocomposite. In some embodiments, the amount of the nanostructures can be less than 0.2% by weight of the nanocomposite. In some embodiments, the amount of microstructures can range from about 10% to about 70 by weight of the nanocomposite.

In some embodiments, the nanocomposite structure can comprise a resin matrix in which the first microfiber, the second microfiber, and the plurality of nanostructures are embedded uniformly therein. In some embodiments, the resin matrix comprises an epoxy polymer. In some embodiments, the first and second microfibers can be comprised within a bundle, tow, or yarn of microfibers that are coupled together by the plurality of nanostructures within the nanocomposite structure.

In some embodiments, each helical tube can have a tube diameter of about 1 nm to about 100 nm. In some embodiments, each helical nanostructure can have a coil diameter of about 50 nm to about 500 nm, from about 100 nm to about 300 nm, or from about 200 to about 300 nm. In some embodiments, the nanocomposite structure can comprise a plurality of microfibers.

In some aspects, a method of forming a nanocomposite structure comprises using a chemical vapor deposition system to vaporize a precursor-catalyst solution to form nanostructures on a substrate, wherein the nanostructures are helical carbon nanotubes, and wherein the substrate comprises a glass fiber foam including a plurality of randomly oriented glass fibers.

The inventors of the present disclosure have combined nanoscience and nanotechnology with the composite science and technology to create the novel nanocomposite systems described herein, which have improved properties, multi-functionality, and performance for a broader range of applications (e.g., applications in the space and aerospace, electronics, biomedical devices, sensors, energy, materials storage, sporting goods and gears, and the automotive industry). Particular embodiments of the subject matter described in this document can be implemented to optionally provide one or more advantages discussed below.

First, various embodiments of the nanocomposites described herein are reinforced with highly entangled and mechanically interlocked nanostructures (or nanomaterials). High levels of entanglement and mechanical interlocking interaction between the nanostructure and other materials (e.g., microstructures and matrix material) within the composite can be achieved by using high-aspect-ratio nanostructures, such as helical carbon nanotubes. These nanostructures are defined with a body shape (e.g., curved or helical body) that promotes entanglement and mechanical interlock with adjacent nanostructures and microstructures within the composite to provide desirable interlaminar and transverse properties to the composite structure. Nano-scale reinforcements that are highly entangled and interlocked with micro-scale reinforcements within the nanocomposite can act as a mechanical medium that resists deformation, movement, prevents mechanical failure of the fiber structures. Furthermore, the interlocking nanomaterials can improve inter-laminar and transverse properties of the composite structure. As such, the unique entanglement and mechanical interlocking features of the nanostructures contained in the composite described herein provide an improved and innovative nanocomposite design.

Second, certain embodiments of the composite structures provided herein are “multiscale” composite structures, which are structures that include a set of reinforcement structures, which have nanoscale dimensions, among a group of reinforcement structures (e.g., fiber strand, tow, bundle, yarn) having microscale dimensions. Nanocomposites that include nanoscale structures within microstructure groupings can have unique properties due to morphological features with nanoscale dimensions of those structures. Mechanical, electrical, thermal, optical, electrochemical, catalytic properties of the nanostructures can be significantly different from the other component materials (e.g., microstructures) contained in the nanocomposite and enhance desired properties beyond those associated with the microscale structures of the nanocomposite. As such, nanocomposite structures incorporated microstructures can yield a high-performance, multi-functional nanocomposite material system that can be utilized for a wide range of applications.

Additionally, certain embodiments of the structures provided herein can be chemically functionalized. Chemical functionalization of HCNTs can improve dispersion and interface atomic bonding with the molecules of the host resin system used for fabrication of traditional composite materials.

While multiple embodiments are disclosed, still other embodiments of the present disclosure will become apparent to those skilled in the art from the following detailed description, which shows and describes illustrative embodiments of the present disclosure. Accordingly, the drawings and detailed description are to be regarded as illustrative in nature and not restrictive.

Unless otherwise defined, all technical and scientific terms used herein have the same meaning as commonly understood by one of ordinary skill in the art to which this invention belongs. Methods and materials are described herein for use in the present invention; other suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

Other features and advantages of the invention will be apparent from the following detailed description and figures, and from the claims.

### DESCRIPTION OF DRAWINGS

FIG. 1A-1B illustrate how exemplary carbon nanotube coils described herein can be entangled and mechanically interlocked with example microfiber-reinforcement strands to provide systems with desirable properties. FIG. 1A shows a schematic illustration showing perspective side view of an exemplary composite structure. FIG. 1B shows a schematic illustration showing a cross-sectional view of an exemplary composite structure.

FIGS. 2A-2D are magnified SEM images of exemplary composite structures containing carbon fibers interlocked together with carbon nanotubes extending within interstitial space between the individual carbon fibers. The straight and curved carbon nanotubes (20-50 nm diameters) are highly entangled and mechanically interlocked together and with carbon fibers (˜6 μm diameters) within a microfiber bundle.

FIGS. 3A-3K are magnified images of various exemplary fibers of composites structures described herein. FIG. 3A shows some example traditional materials (e.g., glass, Kevlar®, and carbon fibers) that can be used in conjunction with the carbon nanotube coils described herein. FIG. 3B shows an example unidirectional carbon fiber tape, without stitching, that the carbon nanotube coils described herein can be used in conjunction with. FIG. 3C shows an example unidirectional carbon fiber tape, with stitching, that the carbon nanotube coils described herein can be used in conjunction with. FIG. 3D shows an example carbon and Kevlar® woven fabric that the carbon nanotube coils described herein can be used in conjunction with. FIG. 3E shows another example carbon and Kevlar® woven fabric that the carbon nanotube coils described herein can be used in conjunction with. FIG. 3F shows another example carbon and Kevlar® woven fabric that the carbon nanotube coils described herein can be used in conjunction with. FIG. 3G shows an example glass-carbon woven fabric that the carbon nanotube coils described herein can be used in conjunction with. FIG. 3H shows an example glass-carbon-Kevlar® hybrid woven fabric that the carbon nanotube coils described herein can be used in conjunction with. FIG. 3I shows an example braided biaxial sleeve construction that the carbon nanotube coils described herein can be used in conjunction with. FIG. 3J shows an example carbon fiber randomly oriented continuous mat that the carbon nanotube coils described herein can be used in conjunction with. FIG. 3K shows an example glass fiber randomly oriented continuous mat that the carbon nanotube coils described herein can be used in conjunction with.

FIGS. 4A-4D are magnified images of exemplary carbon nanotubes. FIG. 4A is an SEM image of example entangled and interlocked coiled and straight carbon nanotubes in accordance with some embodiments provided herein. FIG. 4B is another SEM image of example entangled and interlocked coiled and straight carbon nanotubes in accordance with some embodiments provided herein. FIG. 4C is an SEM image of example individual carbon nanotube coils in accordance with some embodiments provided herein. FIG. 4D is another SEM image of example individual carbon nanotube coils in accordance with some embodiments provided herein.

Some embodiments described herein can include innovative design for a high-performance multifunctional nanocomposite materials system, which includes chemically functionalized nanomaterials in helical configurations with high-aspect-ratios (e.g., carbon nanotube long helical coils). In some embodiments, the nanomaterials can be chemically functionalized. In some embodiments of a nanocomposite materials system, chemically functionalized nanomaterials are highly bent, kinked, twisted, entangled and mechanically interlocked within the resin system and the traditional microfiber reinforcements. Various chemical routes and processes (shown in FIGS. 22-24 and Tables 3-5) were designed, studied, and then tuned for chemical functionalization of helical carbon nanotubes (HCNTs) with 20 optimal performance for applications as nanoscale reinforcements in composite materials systems.

FIG. 5 is a schematic illustration of an example chemical vapor deposition (CVD) system.

FIGS. 6A-6B show images of varying magnification of exemplary nanostructures.

FIGS. 7A-7C are magnified images of an exemplary composite structure containing microfibers and nanotubes extending from surfaces of the microfibers at varying magnifications.

FIGS. 8A-8B show scanning electron micrographs (SEM) images of straight and helical carbon nanotubes.

FIG. 9 is a flow chart providing schematic steps used to process and fabricate exemplary nanocomposite samples.

FIGS. 10A-10B show geometries and dimensions (in millimeters) of (a) tensile test samples; and (b) fracture toughness test samples.

FIGS. 11A-11B show images of: (a) tensile test samples made of pure epoxy; and (b) nanocomposite tensile test samples containing 0.05 wt. % straight multi-wall carbon nanotubes.

FIGS. 12A-12B show images of fracture toughness test specimens for: (a) pure epoxy; and (b) reinforced nanocomposites containing 0.05 wt % helical carbon nanotubes.

FIG. 13 shows images of thermal conductivity samples containing: (a) pristine epoxy and (b) reinforced nanocomposites containing 0.05 wt % multi-wall carbon nanotubes.

FIG. 14 shows images of: (a) dielectric disk electrodes; (b) pristine samples; and (c) nanocomposite samples containing 0.08 wt % multi-wall carbon nanotubes.

FIG. 15 is a bar chart providing a comparison of tensile strength results for post-cured nanocomposite samples with different loadings of straight and helical CNTs by weight percent.

FIG. 16 is a bar chart providing a comparison of tensile modulus results for post-cured nanocomposite samples with different loading percentage of straight and helical CNTs by weight percent.

FIG. 17 is a bar chart providing a comparison of strain to failure results for post-cured nanocomposite samples with different loading percentage of straight and helical CNTs by weight percent.

FIGS. 18A-18D show various magnifications of electron microscopy (EM) images of exemplary nanocomposites. FIG. 18A shows a magnification of an EM image for a fractured surface of an exemplary reinforced nanocomposite with 0.1 wt. % straight multi-wall carbon nanotubes. FIG. 18B shows a magnification of an EM image for a fractured surface of an exemplary reinforced nanocomposite with 0.1 wt. % straight multi-wall carbon nanotubes. FIG. 18C shows a magnification of an EM image of an exemplary reinforced nanocomposite with 0.05 wt. % carbon nano-heli-coils (CNHCs). FIG. 18D shows a magnification of an EM image of an exemplary reinforced nanocomposite with 0.05 wt. % carbon CNHCs.

FIG. 19 is a bar chart providing a comparison of fracture toughness results for post-cured nanocomposite samples with different loading percentage of straight and helical CNTs by weight percent.

FIGS. 20A-B show SEM images of fractured surfaces of fracture toughness samples of exemplary nanocomposites. FIG. 20A shows exemplary reinforced nanocomposites containing 0.1 wt. % straight multi-wall carbon nanotubes. FIG. 20B shows exemplary reinforced nanocomposites containing 0.05 wt. % CNHCs.

FIG. 21 shows dispersion test results as images of vials containing exemplary helical carbon nanotubes (HCNTs), pristine or chemically functionalized (i.e., sonicated with Sulfuric and Nitric acids with 1:1 and 3:1 mixture rations for 3, 6, and 9 hours) in DI water, after one week seating time.

FIG. 22 is a schematic of an exemplary method for functionalization of HCNTs.

FIG. 23 is a schematic of an exemplary method for functionalization of HCNTs.

FIG. 24 is a schematic of an exemplary method for functionalization of HCNTs.

FIG. 25 shows dispersion test results as images of vials containing exemplary functionalized HCNTs according to Example 3, after 1 hour, 6 hours, 24 hours, 48 hours, and 1 week.

FIG. 26 shows dispersion test results as images of vials containing exemplary functionalized HCNTs according to Example 3, after 1 hour, 6 hours, 24 hours, 48 hours, and 1 week.

FIG. 27 shows dispersion test results as images of vials containing exemplary functionalized HCNTs according to Example 3, after 1 hour, 6 hours, 24 hours, 48 hours, and 1 week.

FIG. 28 shows dispersion test results as images of vials containing exemplary functionalized HCNTs according to Example 3, after 1 hour, 6 hours, 24 hours, 48 hours, and 1 week.

FIG. 29 shows dispersion test results as images of vials containing exemplary functionalized HCNTs according to Example 3, after 1 hour, 6 hours, 24 hours, 48 hours, and 1 week.

FIG. 30 shows dispersion test results as images of vials containing exemplary functionalized HCNTs after 1 hour, 6 hours, 24 hours, 48 hours, and 1 week.

FIG. 31A-31D shows SEM images of exemplary functionalized HCNTs (FHCNTs) that were functionalized according to Method 3 of Example 3. FIG. 31A is at 5000× magnification. FIG. 31B is at 10000× magnification. FIG. 31C is at 15000× magnification. FIG. 31D is at 22000× magnification.

The patent or application file contains at least one drawing executed in color. Copies of this patent or patent application publication with color drawing(s) will be provided by the Office upon request and payment of the necessary fee.

### DETAILED DESCRIPTION

This document relates to reinforced nanocomposite structures. In particular, this document describes nanocomposite structures containing reinforcement microstructures that are mechanically interlocked together with nanostructures. Certain embodiments of the nanocomposite structures provided herein include microfibers mechanically interlocked together with helical nanostructures. Certain embodiments of the helical nanostructures provided herein include helical carbon nanotubes.

In some embodiments, chemical functionalization of helical nanotubes, including helical carbon nanotubes, for high-performance multifunctional nanocomposite materials systems is also provided herein. In some embodiments, the nanocomposite materials systems described herein can have chemically functionalized nanomaterials that are highly bent, kinked, twisted, entangled and mechanically interlocked within the resin system and the traditional microfiber reinforcements to meet demands for high-performance materials with desired properties and multifunctional capabilities for a wide range of applications.

This disclosure describes the combination of nanoscience and nanotechnology with conventional composite science and technology. The nanocomposite structures provided herein can have one or more improved properties, multi-functionality, and performance characteristics that can be broadly applied to a range of applications, including space and aerospace structures, electronic and biomedical devices and sensors, energy and materials storage, sporting goods and gears, and parts used in the automotive industry. Materials described herein can provide high-performance properties in contexts such as, but not limited to, structural load carrying, efficient heat transfer, and efficient electricity transfer, to provide a few examples.

It has been found that, owing to their remarkable properties, nanostructures, including carbon nanostructures, are highly useful candidates for reinforcements in through-the-thickness direction. Three-dimensional reinforced nanocomposites described herein have been developed using high-density arrays of vertically aligned carbon nanotubes (“CNTs”) directly grown on various types of fabrics. As a result fracture toughness, flexural modulus and strength, flexural toughness, damping, coefficient of thermal expansion (CTE), through-the-thickness thermal and electrical conductivities were improved. Experimental results demonstrate that the adhesion of adjacent fabric layers can be considerably improved by introduction of CNT nanoforests normal to the laminae. Such advanced state of the technology is of tremendous interest to the space and aerospace industry.

In some embodiments, CNTs can be grown on various fiber bundles and fabrics at elevated temperatures (e.g., 770° C.).

In other embodiments, CNTs can be grown at lower temperatures that may reduce the chance of damaging the fiber by temperature exposure. In some prior work with nanotubes, CNTs may all be substantially straight with no mechanical entanglements with individual fiber strands and/or with the laminae. Furthermore, the nanotubes were grown only on the fibers that were positioned on the outside periphery of the fiber bundles and tows that constructed the fabrics. Therefore, previously proposed methods do not introduce nanomaterials in between the individual fiber strands within the fiber bundles/tows/yarns that make up the reinforcing fabrics.

In this document, the term “nanoscale” can be defined as a dimension ranging from 0.1 nanometer to 1000 nanometers. The term “microscale,” as defined herein, can refer to a dimension greater than 1000 nanometers.

A “nanostructure” can include a structure that has at least one of its dimensions within the nanoscale range (i.e., from 0.1 nanometer to 1000 nanometers). A “microstructure” can include a structure that has its smallest dimension within the microscale (i.e., greater than 1000 nanometers).

A “nanoscale material” can include a natural or synthetic material containing nanoscale structures (which may also referred to “nanostructures”) such as fibers, particles and the like, in an unbound state or as an aggregate or agglomerate.

A “nanocomposite,” as defined herein, can include a structure containing a solid combination of a bulk matrix of micro- and nano-dimensional phase(s) differing in properties due to dissimilarities in structure and chemistry.

A “high-aspect-ratio nanostructure,” as defined herein, is a nanostructure wherein at least one of its dimensions is at least ten times larger than its smallest dimension.

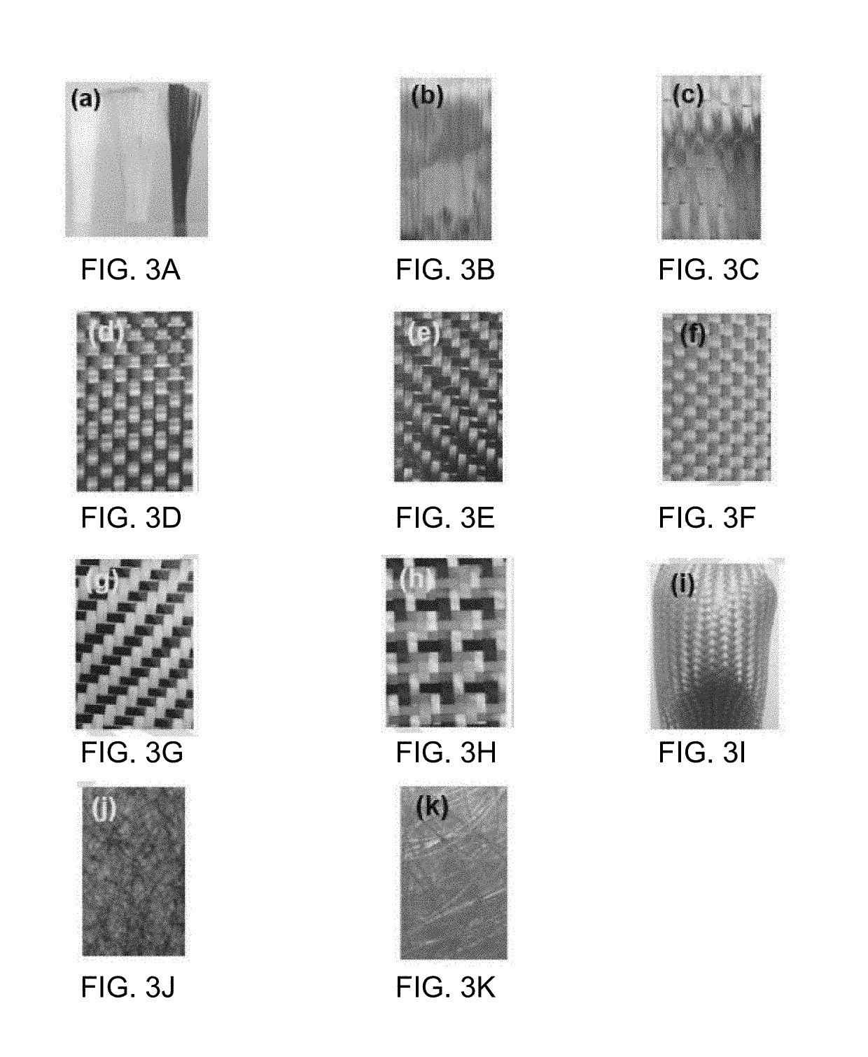

Considering the diameters of the fiber filaments that are used as reinforcements in traditional laminated high-performance composites (e.g., 5 to 30 micrometers), they are usually produced in bundle/tow/yarn forms (e.g., thousands of fiber strands twisted together or bundled side-by-side) and then woven together to create fabrics with different textures and composition or put together side-by-side to create unidirectional mat and tapes (e.g., see FIGS. 3A-3K). In both forms, the nanomaterials reinforcements can be introduced in between the fiber tows/bundles/yarns within the woven fabrics or unidirectional/bidirectional tapes and mats. In some embodiments, incorporation of chemically functionalized nanomaterials in helical configurations in between individual fiber strands within the fiber bundle/tows/yarns, is described. Traditional composite communities do not design or optimize the composite materials systems in such nanoscale details with improved interface bonding between the nanoscale reinforcement and the resin molecules, as described herein. In addition, in traditional composite materials systems there is no mechanical entanglement/interlocking element to anchor the resin system to the microfiber reinforcements; however, in some embodiments of a nanocomposite material system described herein, helical nanostructures (e.g., HCNTs), including functionalized helical nanostructures (e.g., FHCNTs), are mechanically locked in the solidified resin and also entangled and interlocked with microfiber reinforcements.

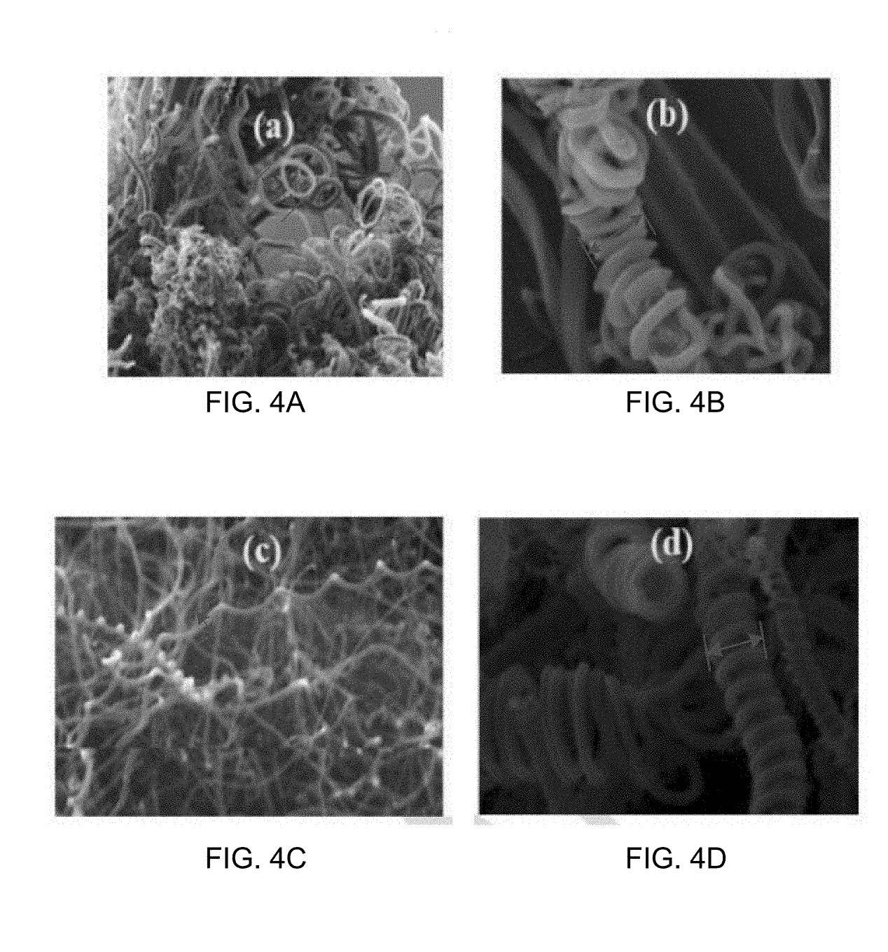

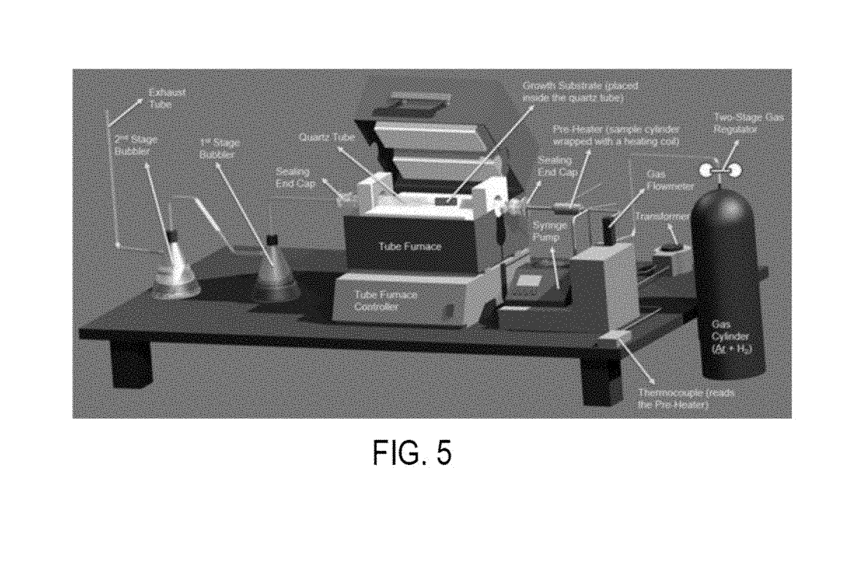

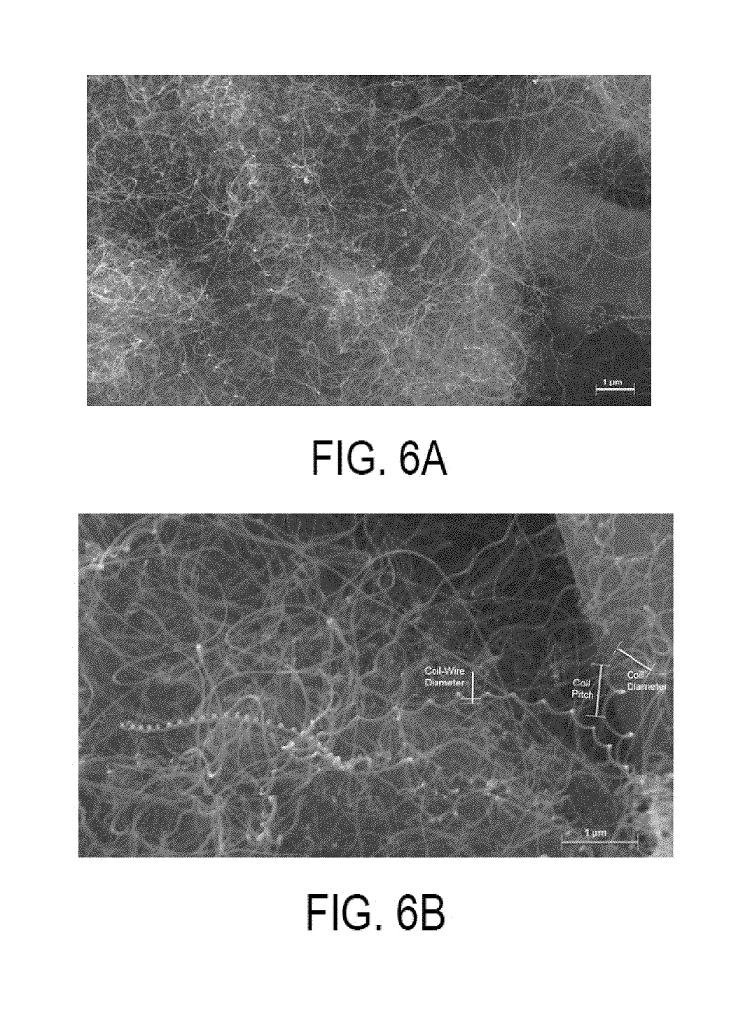

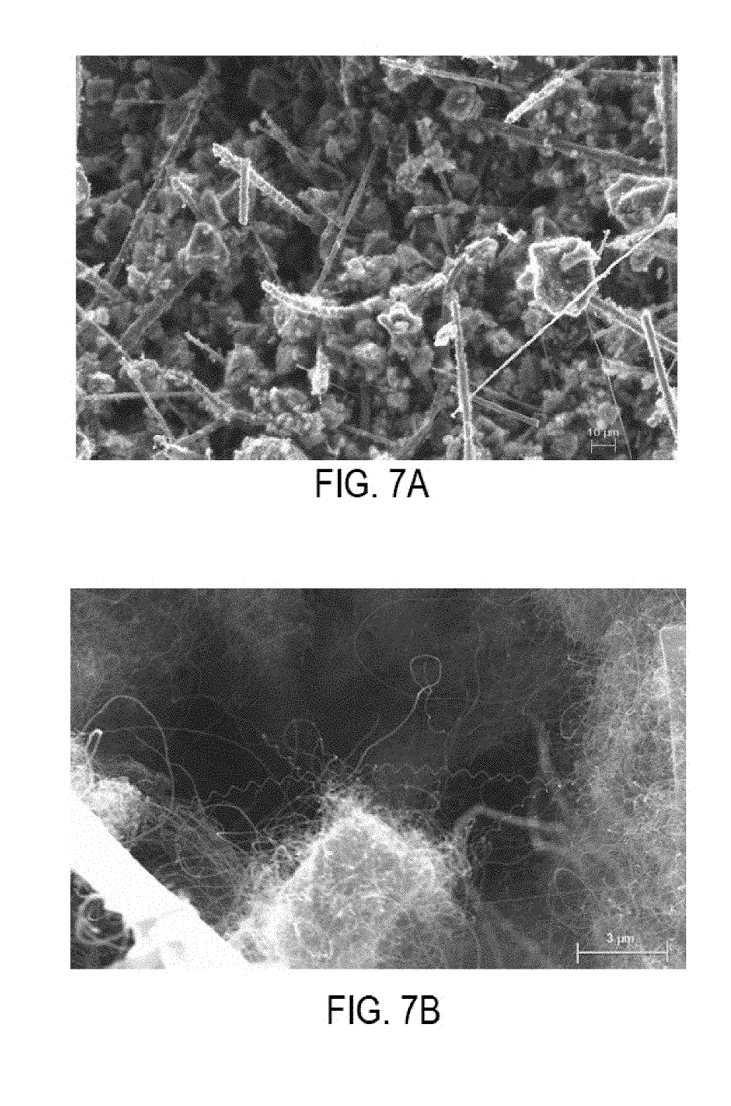

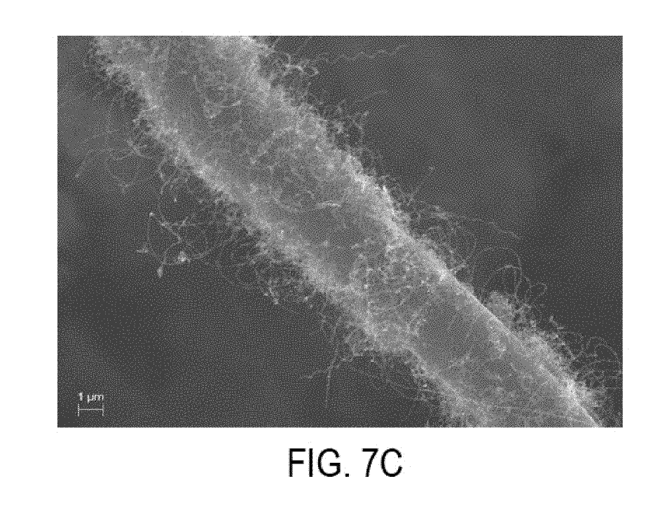

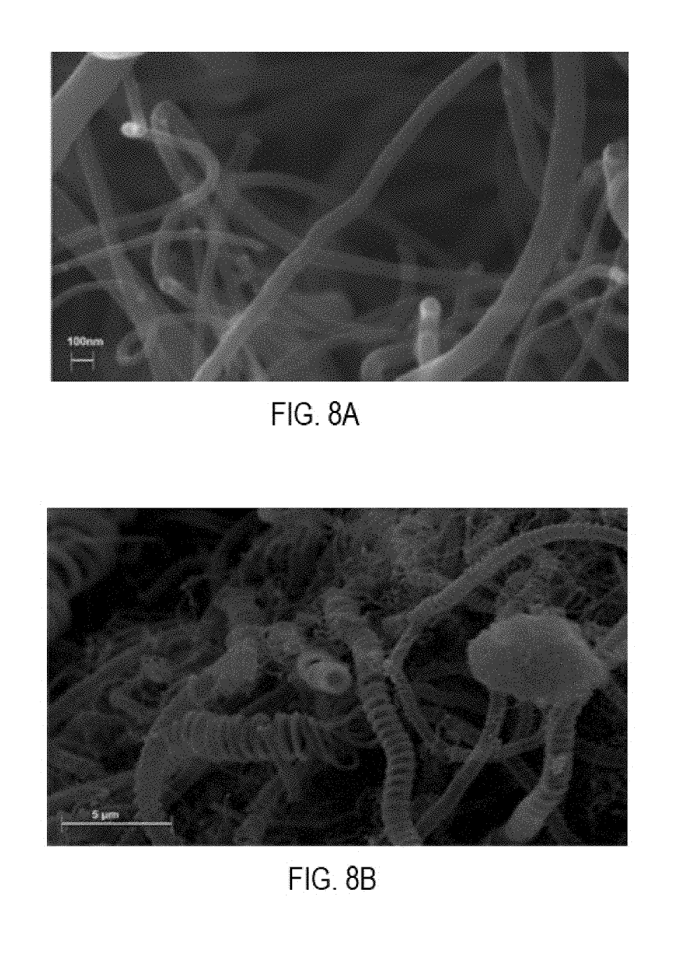

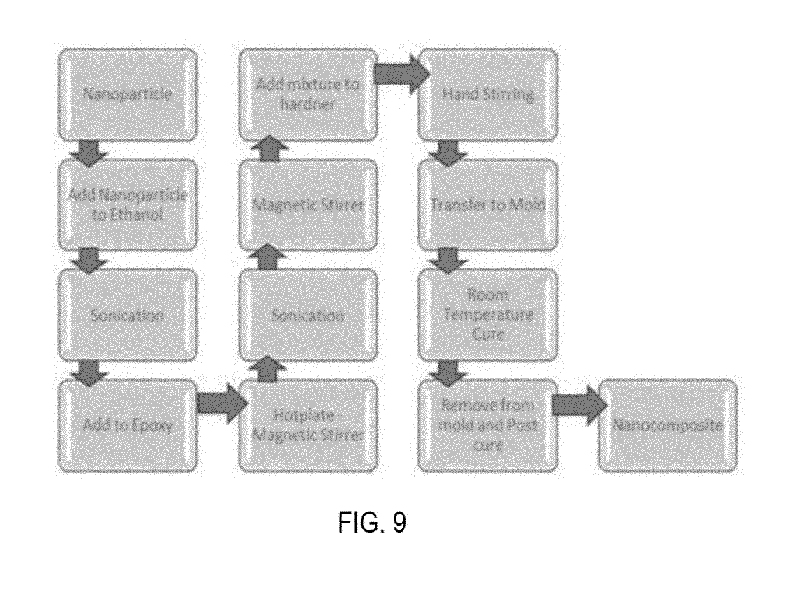

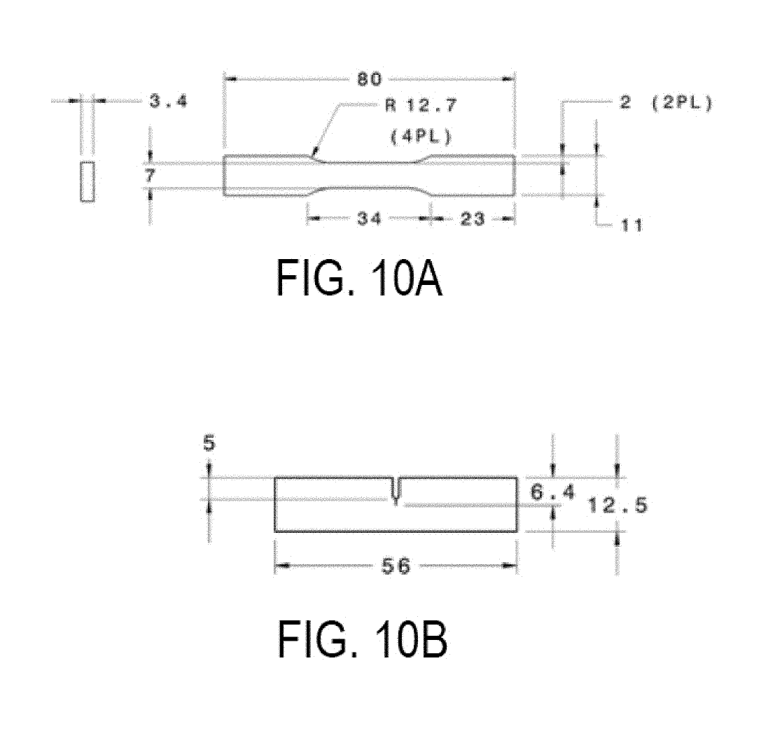

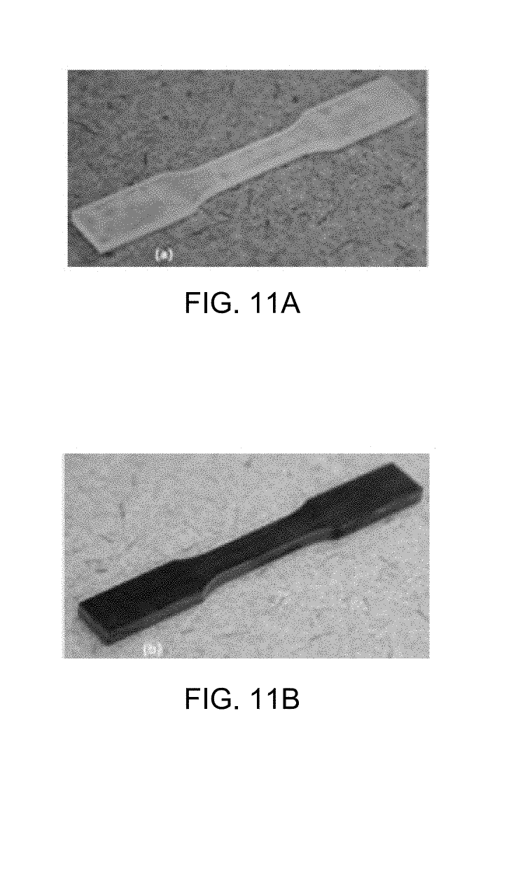

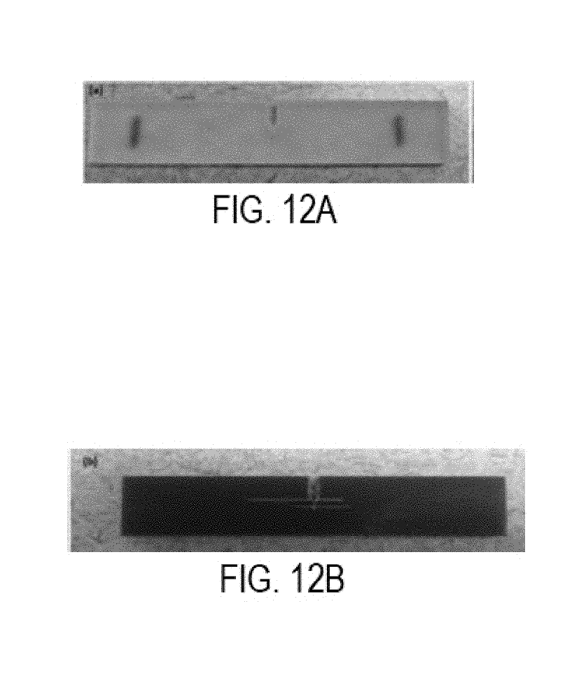

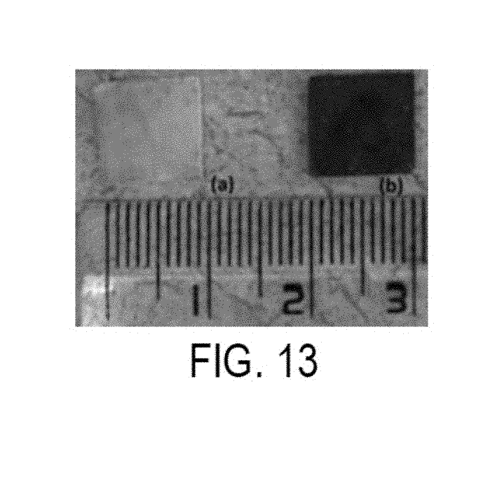

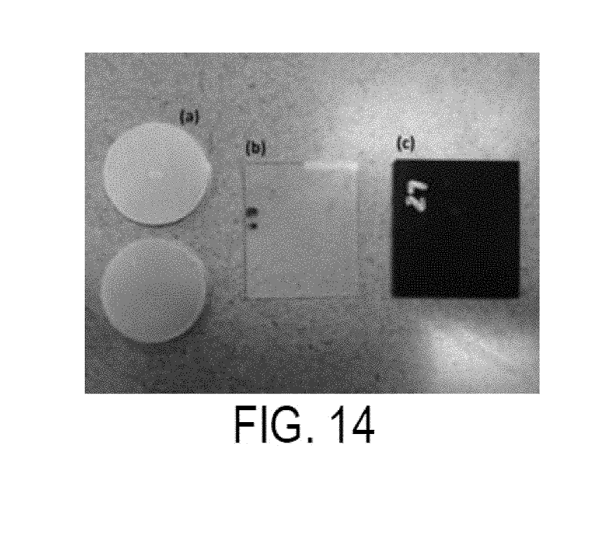

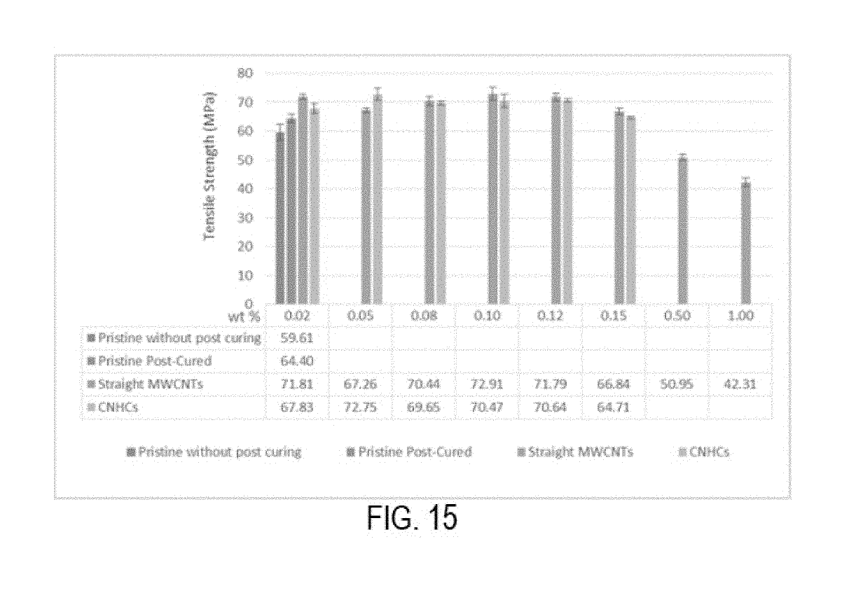

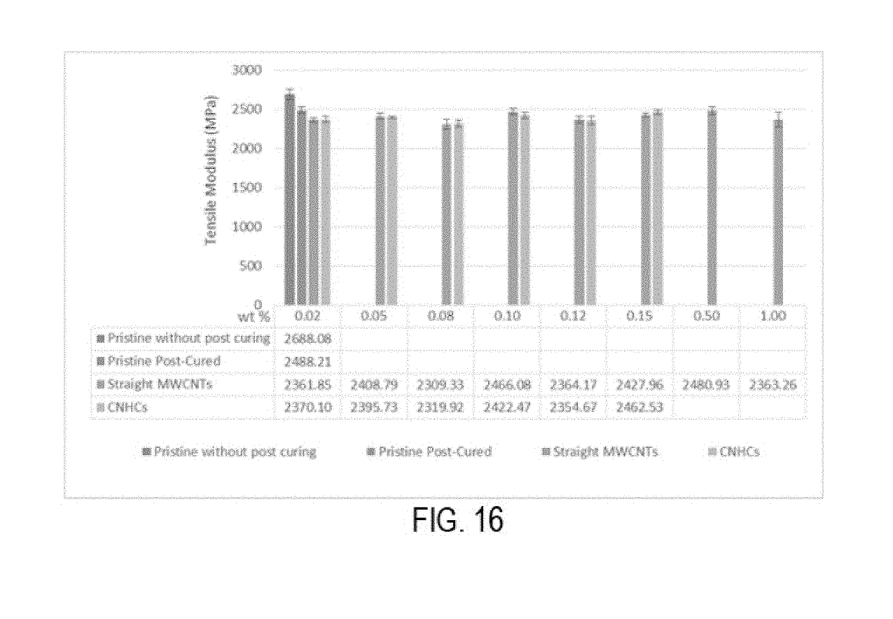

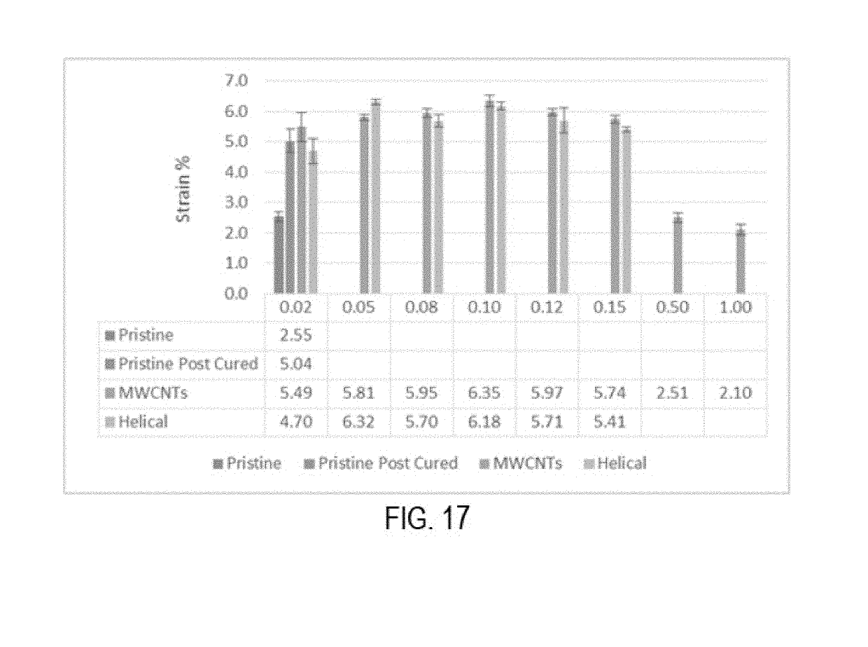

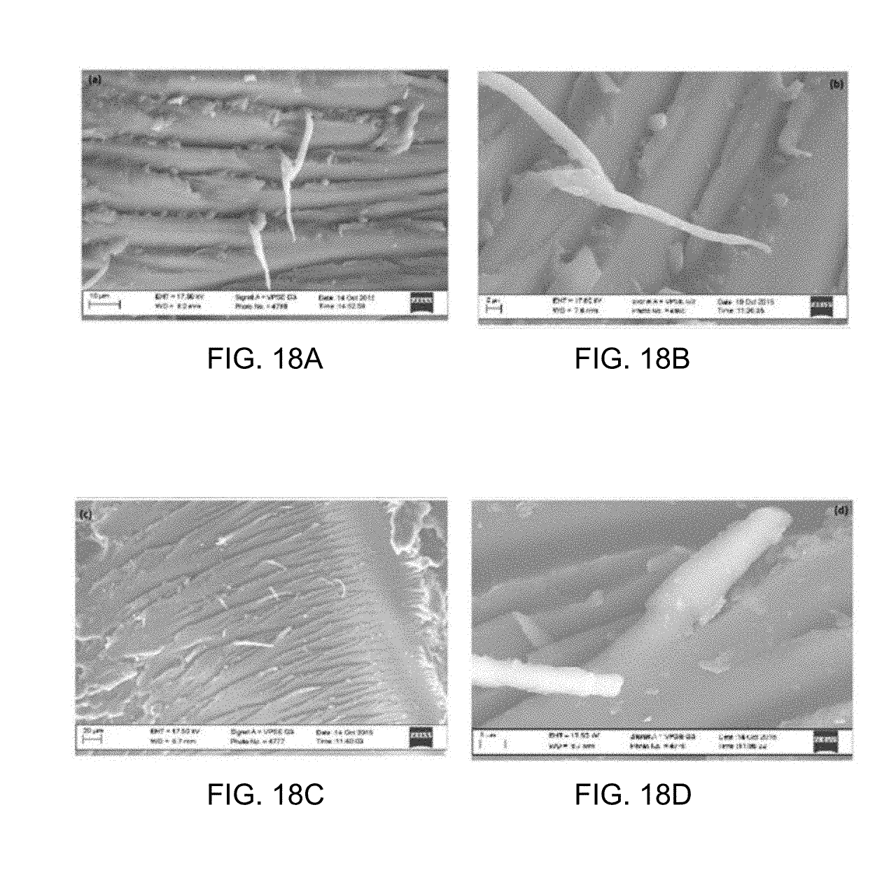

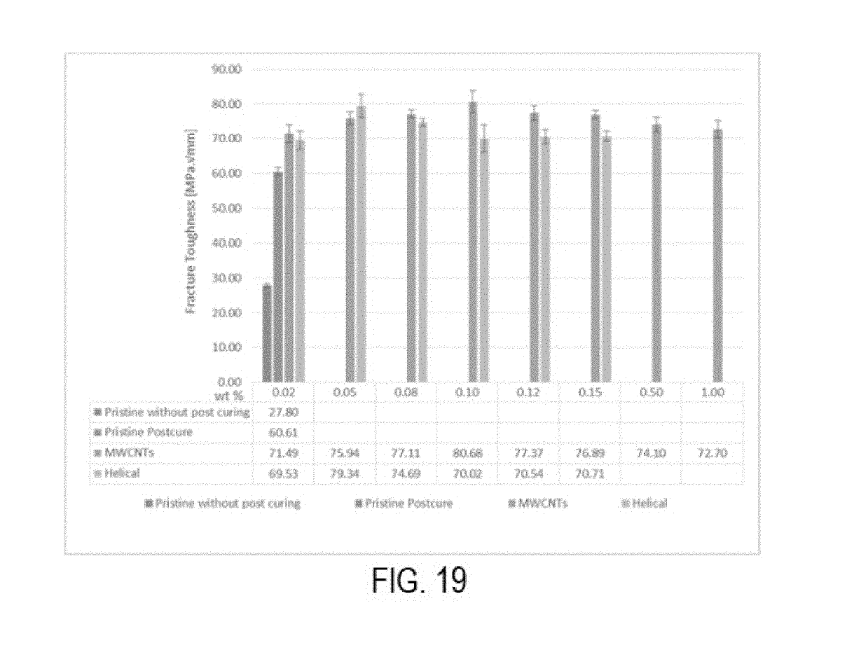

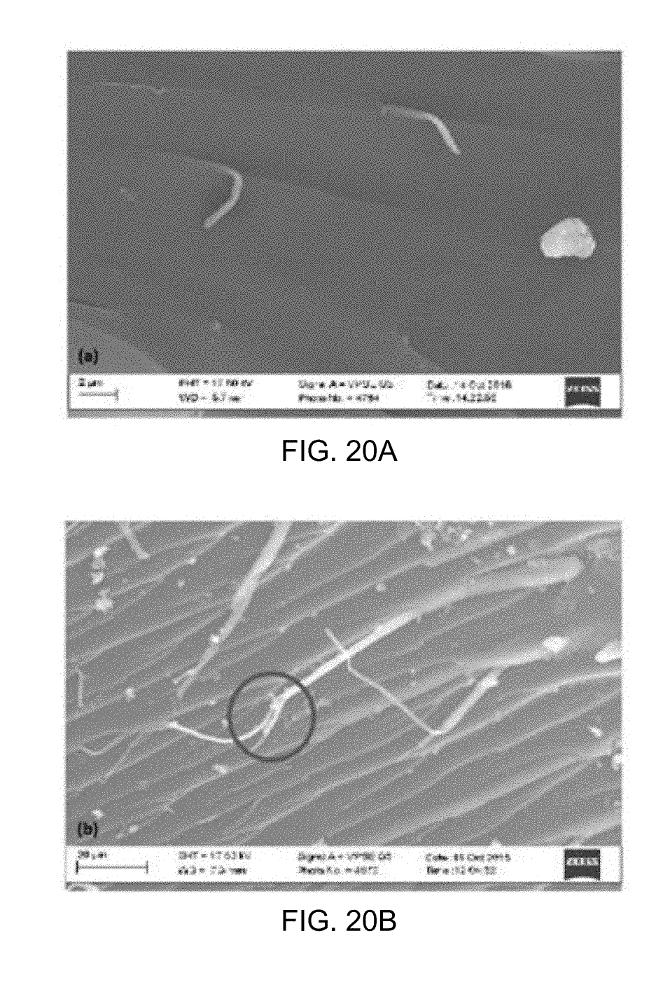

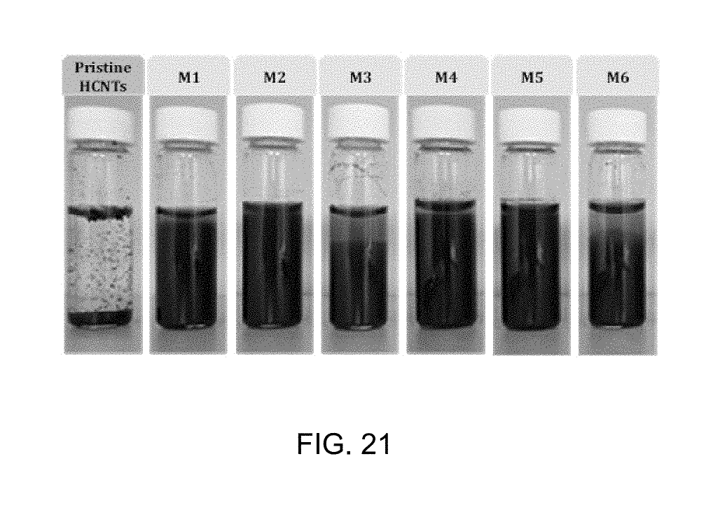

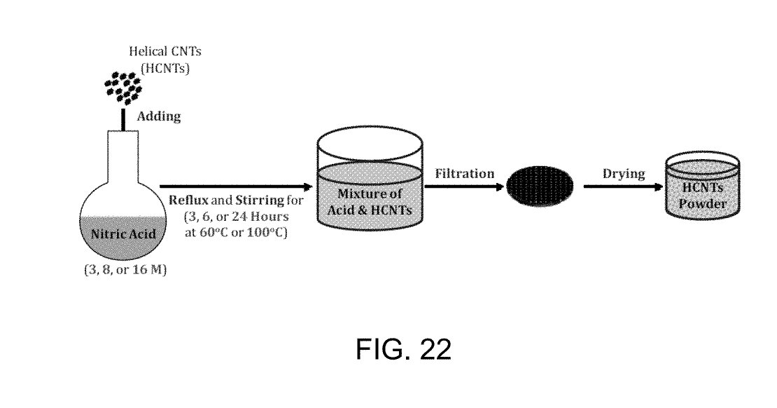

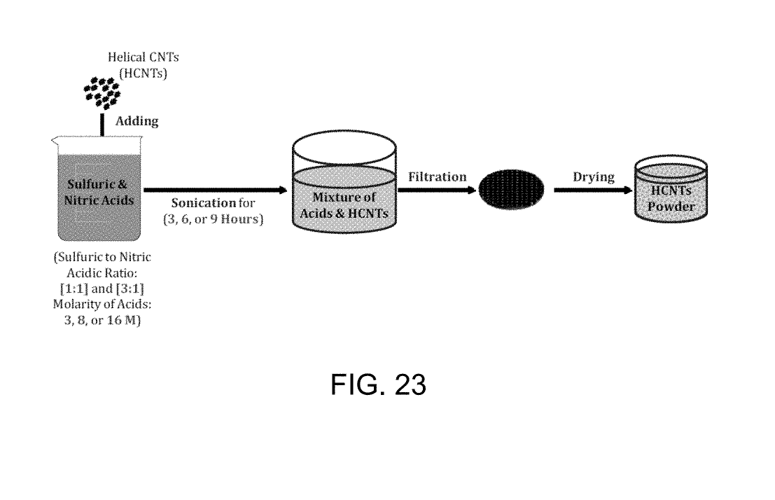

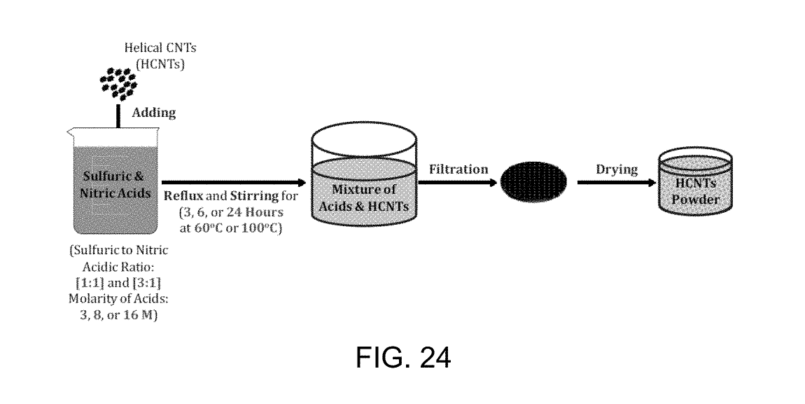

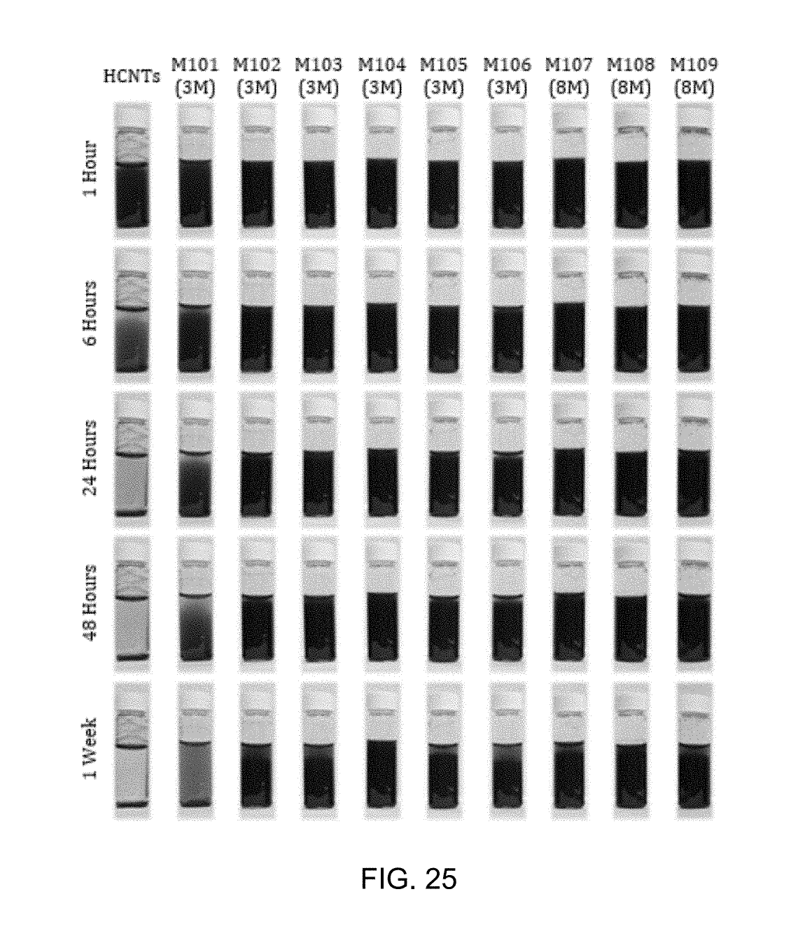

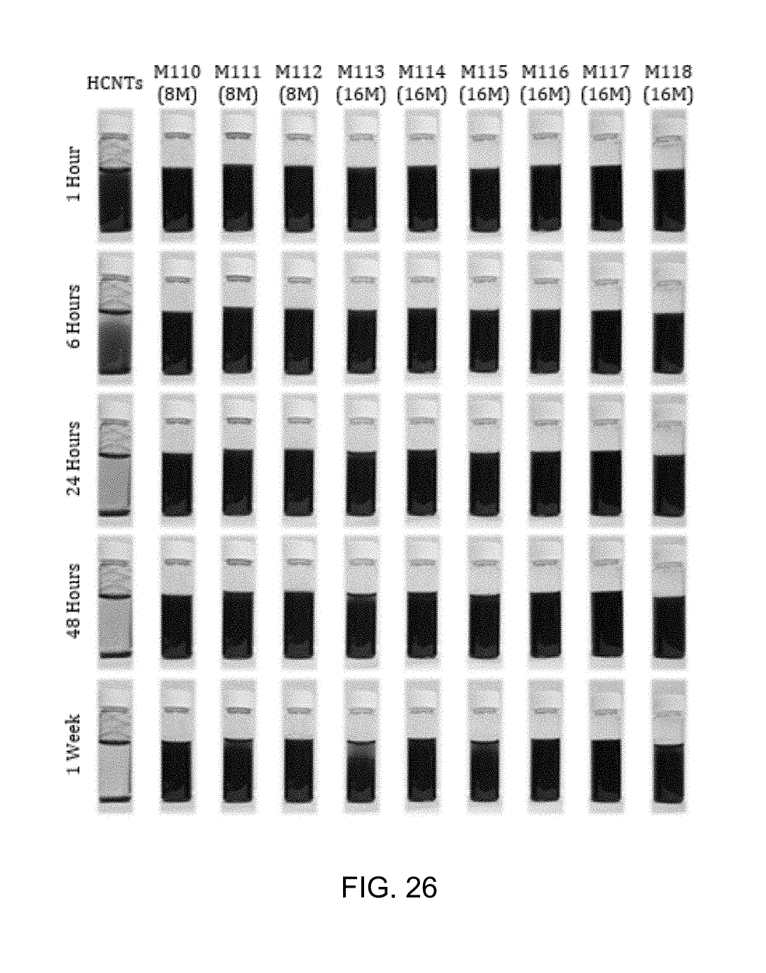

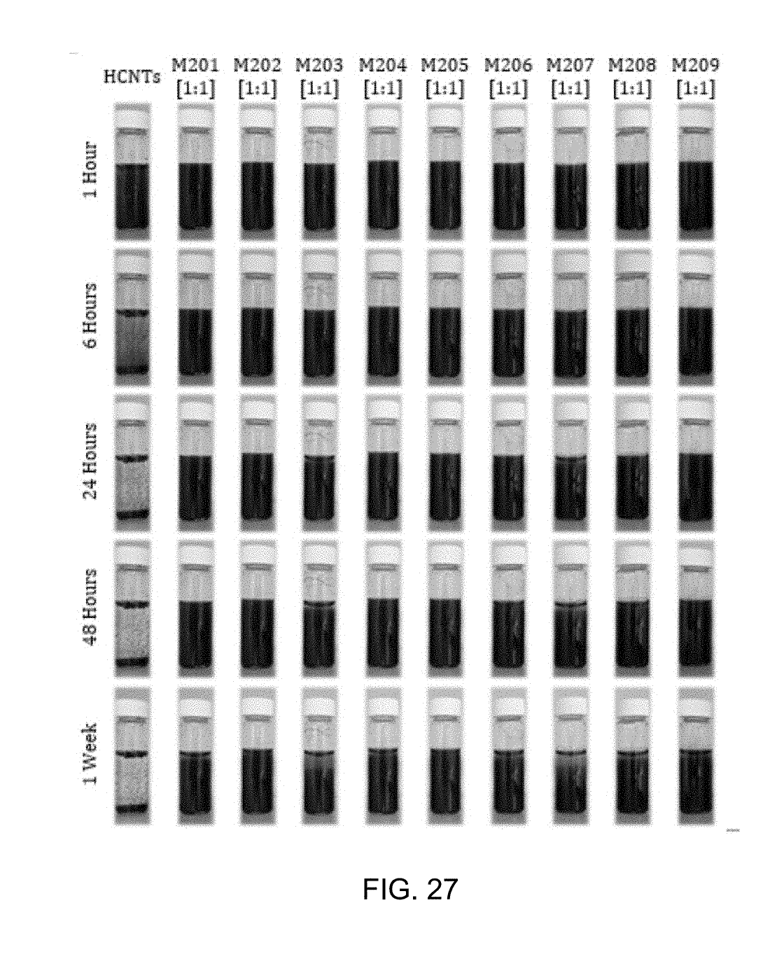

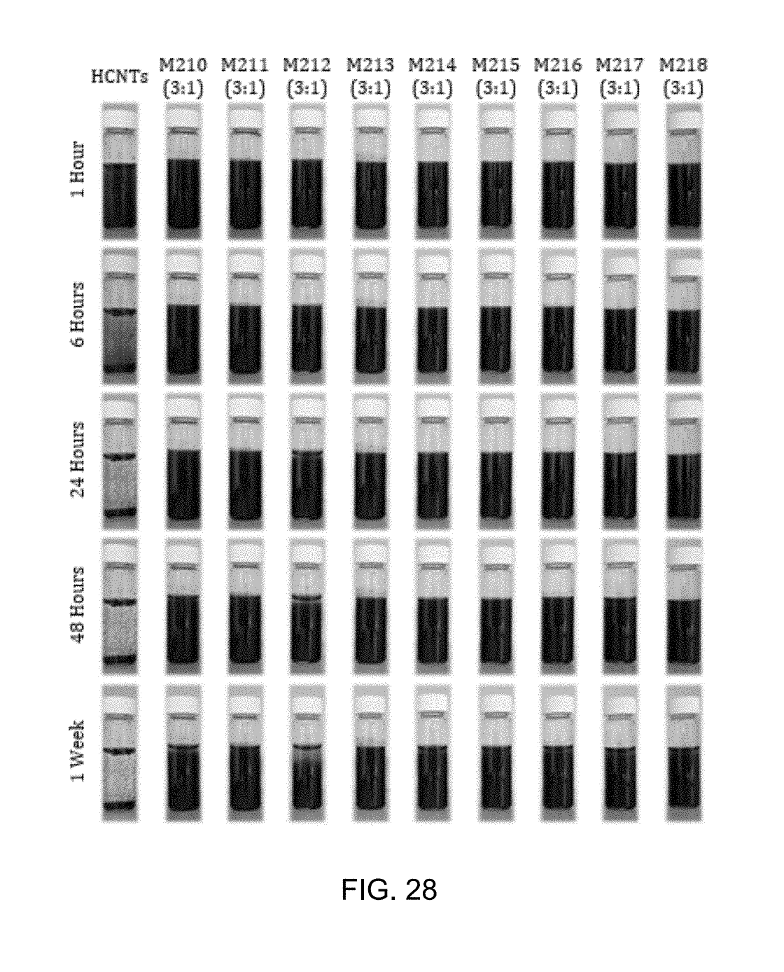

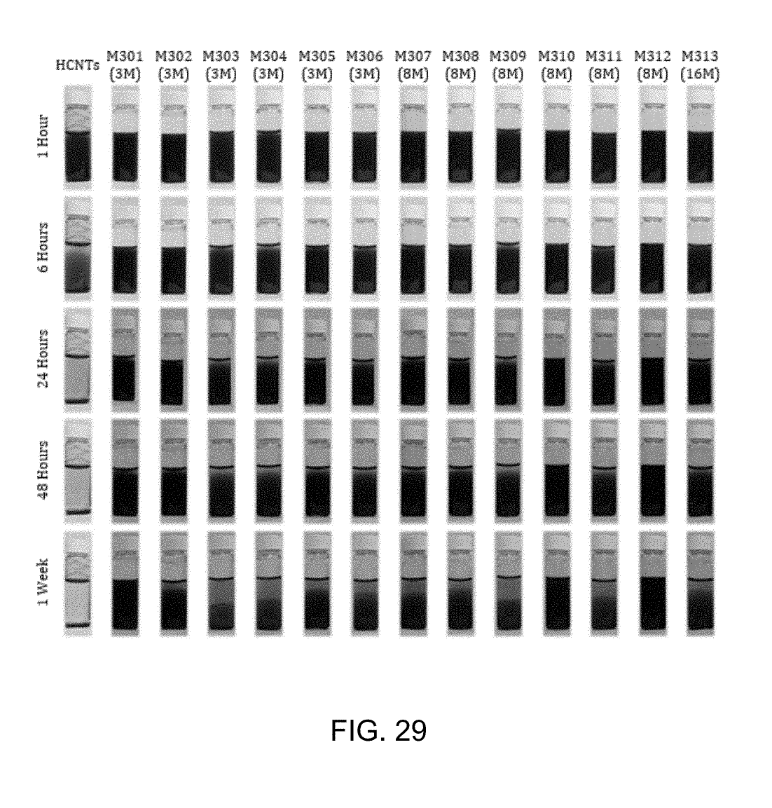

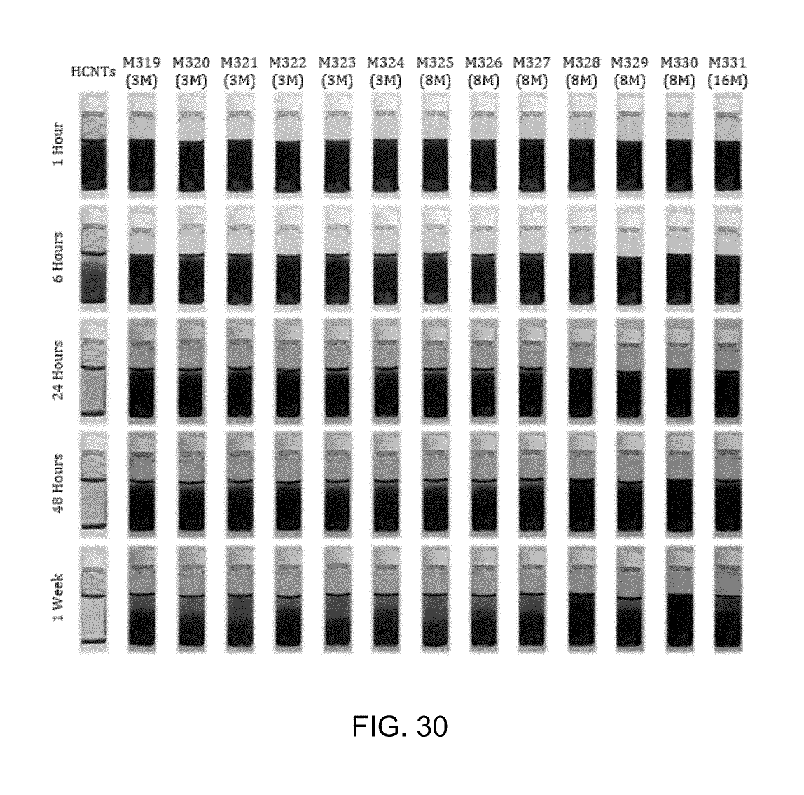

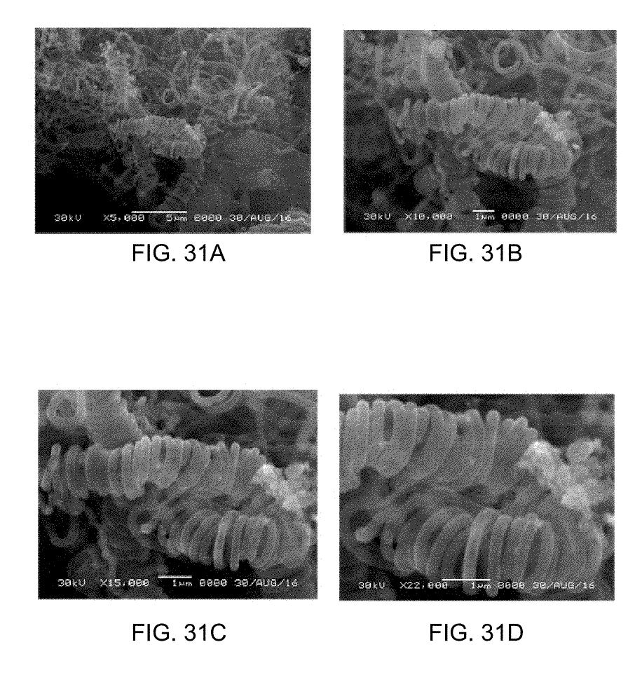

Some embodiments of the nanocomposite materials systems described herein can be somewhat analogous to the structures of some very high-performance natural fibrous materials that have been observed in plants (e.g., silk, spider net, and bird nest) and some living animal's certain organs (e.g., gecko foot). Nanostructured materials, even in very small quantities, provide tremendously large surface areas and interfaces that can participate in chemical reactions, form chemical bonds with adjacent materials, or provide attractive Van der Waals forces, in billions of billions in number (e.g., see FIGS. 4A-4D).

In addition to the improved chemical bond formations and attractive Van der Waals forces at the interfaces of nanomaterials (that are present in billions of billions), the resin molecules and individual fiber strands can also be mechanically entangled and interlocked with individual microfiber strands and the cured matrix. Such a highly entangled and mechanically interlocked multiscale materials system, including a chemically functionalized system, can present exceptionally high mechanical, thermal, and electrical properties, with higher durability, when they are exposed to harsh environmental conditions. Such structures address one of the most common problems and weaknesses of known composite material systems (i.e., low interlaminar and through-the-thickness properties). Hence, the structures described herein can greatly advance the composite materials industry in a wide range of high-performance materials applications.

The highly-reinforced nanocomposite materials systems (including chemically functionalized nanocomposite materials systems) as described herein can be used to make high-performance materials for a wide range of applications where traditional composites materials are commonly used (e.g., marine and submarine structures, space and aerospace structures, wind turbines, biomedical devices and sensors, electronics, MEMS and NEMS, sporting goods, automotive industry, building materials, transportation industry, piping, materials storage, etc.). Embodiments described herein will benefit the space and aerospace, marine and submarine, automotive, sport, medical, electronic, oil and gas, and renewable energy related industries. Moreover, the technology described herein can easily be scaled up to produce high-performance FHCNTs reinforced multifunctional nanocomposite material systems in large quantities that are highly reliable and reproducible.

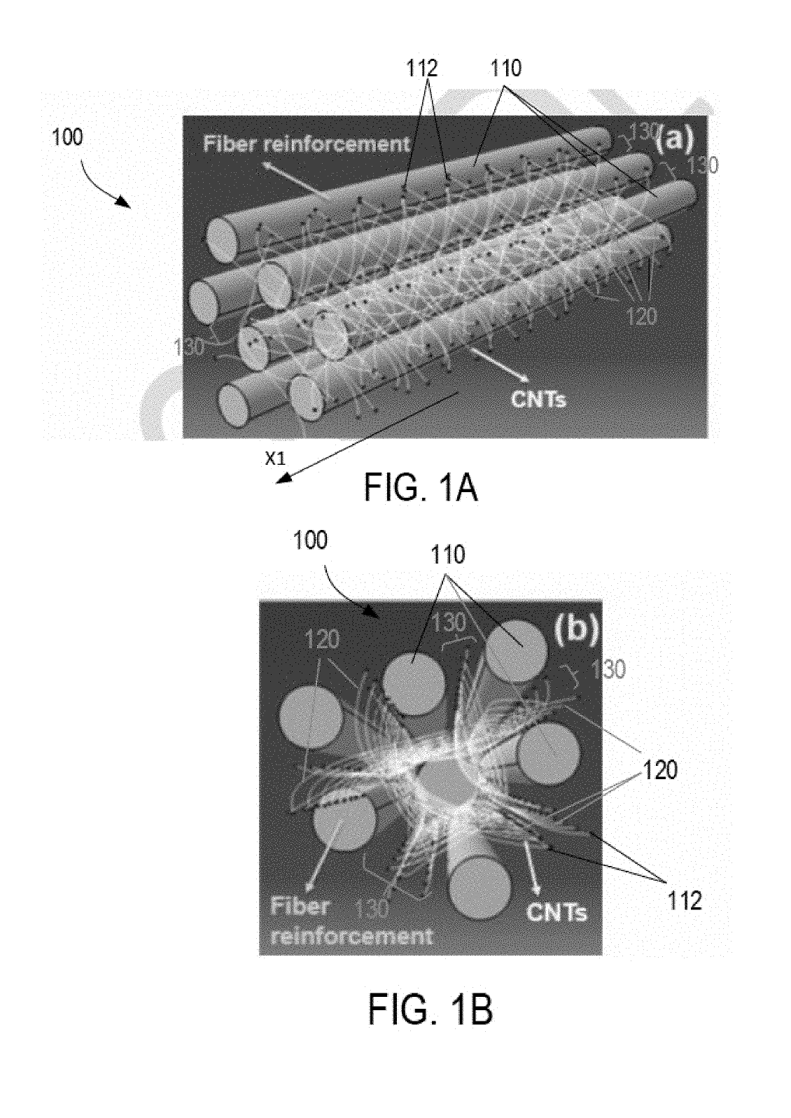

FIGS. 1A and 1B show perspective side and cross-sectional views of an example nanocomposite structure 100 (which may also be referred to as a “nanocomposite system”). In some embodiments, the nanocomposite structure 100 can be pristine, without chemical functionalization. In other embodiments, nanocomposite structure 100 can be chemically functionalized. The depicted nanocomposite structure 100 includes a micro-reinforcement phase and a nano-reinforcement phase. The micro-reinforcement phase includes multiple microstructures 110 having micro-scale dimensions. The nano-reinforcement phase includes a plurality of interlocking nanostructures 120 (and/or nanomaterials) having nano-scale dimensions. The micro-reinforcement and nano-reinforcement phases can be uniformly distributed throughout the nanocomposite structure 100. In some embodiments, the nano-reinforcement phase can be selectively distributed in discrete locations or portions of the micro-reinforcement in the nanocomposite structure 100

The nanocomposite structure 100, as shown in the figures, can be described as a mechanically interlocked, multiscale material system containing microstructures 110, such as microfibers, that are mechanically interlocked (e.g., entangled) together with interlocking nanostructures 120, such as carbon nanotubes (“CNTs”). The depicted nanostructures 120 (e.g., CNTs) are disposed between individual microstructures 110 (e.g., a microfiber) within a group of the microstructures (e.g., a fiber strand, such as a bundle, tow, or yarn). Each nanostructure 120 (e.g., CNTs) within nanocomposite structure 100 can originate from an origin point 112 on a surface of one of the microstructures or suspended in interstitial gaps and extend radially from that surface. The nanostructures 120 can extend from the origin point 112 and through interstitial gaps 130 defined between two or more microstructures 110, as shown in FIG. 1B. In the interstitial gaps, the nanostructures can entangle and interlock with one another as well as a group of microstructures 120 together.

The nanocomposites provided herein incorporate nanostructures in between the individual microstructures (e.g., microfibers) within a group of microstructures (e.g., fiber bundle/tows/yarns). As such, nanocomposites provided herein optimize the nanocomposite on a nanoscale level. Nanocomposite materials system provided herein can include synthetic systems that resemble or mimic structures of high-performance fibrous materials that are found in nature (e.g., bird's nest, or gecko webbed feet). These nanostructures, even in very small quantities, can provide the advantage of providing significant amounts of surface areas. Furthermore, such nanostructures can provide interfacial regions that can participate in chemical reactions, form chemical bonds with adjacent materials, or form attractive Van der Waals forces.

Due to their superior materials properties, helical geometrical configurations, and improved interface bonding with the resin system, the presence of high-aspect-ratio chemically functionalized helical nanomaterials and nanostructures that are highly entangled and mechanically interlocked with each other and each and every microfiber-reinforcement within each microfiber bundle/tow/yarn, the HCNTs will considerably improve the load transfer capability of the resin system. HCNTs can also participate to carry structural loads and transfer heat and electricity, very efficiently. In addition, the functionalized nano-reinforcement phase, which is highly entangled and interlocked with the microfiber-reinforcement phase, will act as a mechanical medium that will resist the deformation, movement, failure of the microfibers and, as a result, it will improve the inter-laminar and transverse properties of composite structures.

Still referring to FIGS. 1A-1B, nanocomposites structures 100 contain multiple microstructures 110 (e.g., microfibers) that extend along a longitudinal axis “X1” generally defined by the individual microstructures. In some embodiments, as depicted, a majority of the microstructures 110 or all of the microstructures 110 can extend along one longitudinal axis (e.g., X1). In some embodiments, a portion of the microstructures 110 can extend along a first longitudinal axis while another portion of the microstructures 110 extend along a second longitudinal axis. The first and second longitudinal axes can be oriented orthogonally or obliquely positioned to each another. In some embodiments, a portion of or all of the microstructures 110 can be randomly oriented, bent, and/or curved within the composite structure 100.

The nanocomposite structure 100 can include a resin matrix in various embodiments. Microstructures and nanostructures can be embedded, either uniformly or discretely, in the resin matrix. The resin matrix can be disposed in the interstitial gaps between the microstructures 120 within the nanostructure, such that nanostructures are dispersed in the resin matrix and in between the microstructures. The resin matrix can include one or more polymers, metals, and ceramic materials in raw, chemically modified, or nanomaterials-reinforced forms. Exemplary resin materials can include thermoplastic and thermoset polymers (e.g., epoxy polymers, phenolic, polyesters, polystyrenes, polyethylene, polycarbonates, polyetheretherketone, nylons, polymethylmethacrylate, polyvinylchloride, etc.), metallic resins (e.g., aluminum and its alloys), ceramic matrices (e.g., Kion Ceraset) or combinations thereof. In some embodiments, the matrix can be a cured matrix that include curable materials, such as epoxy polymers, and other polymeric, metallic, and ceramic resins, mentioned above.

The nanocomposite structures 100 can include a range of suitable weight percentages of nanostructures (e.g., 0.02%-2% by weight), microstructures (i.e., up to 65% by weight), and resin matrix (i.e., 30-60% by weight).

The weight percentage of the nanostructures in the nanocomposite may be configured to provide the nanocomposite structures with suitable mechanical, chemical, or physical properties. For example, in some embodiments, the nanocomposite can include the nanostructures in an amount ranging from about 0.02% to about 1% by weight (e.g., from about 0.02% to about 0.5%, from about 0.02% to about 0.3%, from about 0.02% to about 0.2%, from about 0.02% to about 0.1%, from about 0.02% to about 0.05%, from about 10% to about 20%, from about 20% to about 30% by weight, or from about 30% to about 50% by weight) of the nanocomposite. In some cases, nanocomposites include the nanostructure in an amount of less than 1%, 0.9%, 0.8%, 0.7%, 0.6%, 0.5%, 0.4%, 0.3%, 0.2%, 0.15%, 0.12%, 0.1%, 0.08%, 0.05%, 0.02% of the nanocomposite.

In some embodiments, nanocomposite structures 100 provided herein can include at least one coating or film (e.g., polymer, rubber, ceramic, metal, etc.) disposed at a surface of the composite. The coating or film can be advantageous in protecting the composite against wear caused by environmental conditions (e.g., heat, light, UV, moisture, etc.), or can be applied for aesthetic appeal (e.g., adds a desired color or texture).

Mechanically interlocked multiscale nanocomposites provided herein can present exceptionally high mechanical, thermal, and electrical properties. In some embodiments, desirable properties achieved can include higher durability under harsh environmental conditions. For example, mechanical interlocking can increase interlaminar and through-the-thickness properties of the nanocomposite and thus provide a suitable materials for a wide range of high-performance applications.

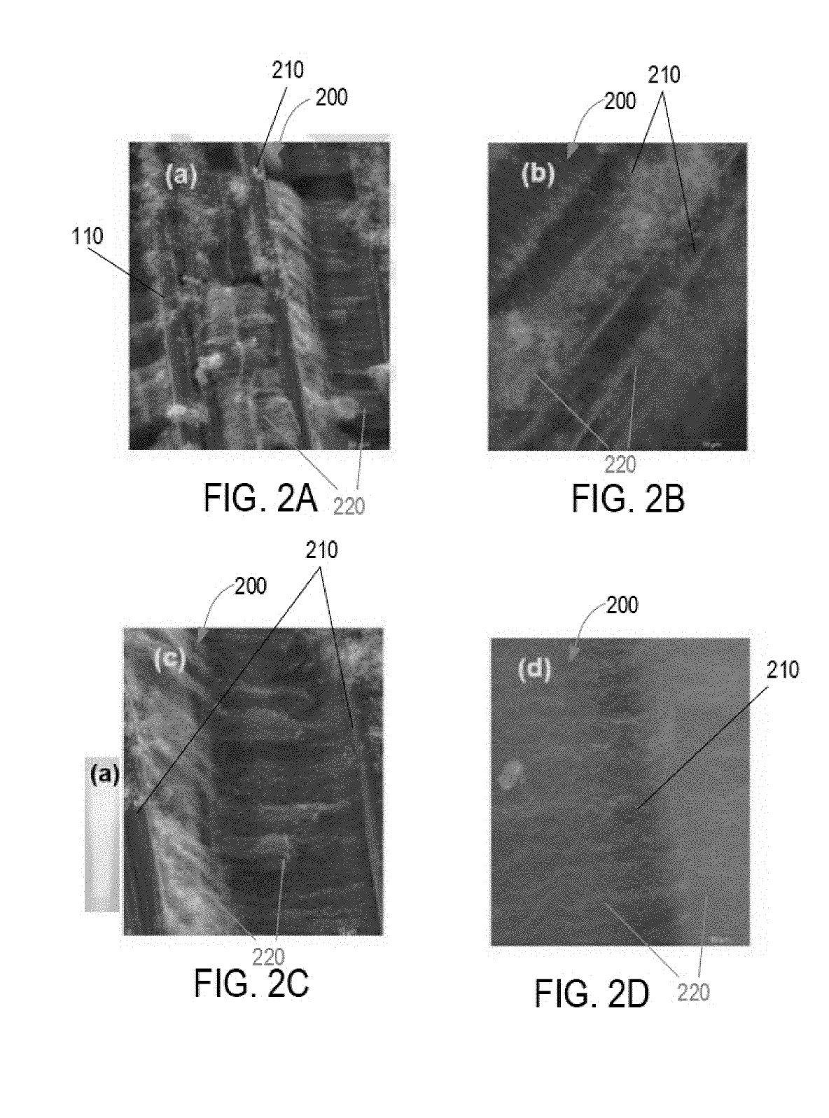

FIGS. 2A-2D are magnified images of exemplary nanocomposite structures 200 containing carbon fibers 210 (microstructures) interlocked together with CNTs 220 (nanostructures) extending through interstitial gaps between individual carbon fibers 210. The diameter of carbon fiber microstructures 210, shown in FIGS. 2A-2D, is approximately 6 microns. Specifically, the images show composition structures including microfiber bundles that contain microscale carbon nanotubes (CNTs), which have diameters ranging from about 2- to 50 nm, entangled and mechanically interlocked together with microscale carbon fibers, which have diameters of about 6 microns.

Nanostructures can extend through interstitial gaps between the microstructures that are filled with a matrix resin in various suitable ways. As best shown in FIGS. 2A and 2C, in some embodiments, the nanostructures 220 can extend in a common direction between the microstructures 210. In some embodiments, the nanostructures 220 can extend in various random directions away from a microstructure surface toward other proximally located microstructures 110, as best shown in FIG. 2B. In some embodiments, the nanostructures extend with a non-linear (e.g., undulating) pattern through the interstitial gaps, as best shown in FIG. 2D. In various embodiments of the composites provided herein, nanostructures 220 can interact with (e.g., entangle, mechanically interlock, wrap around) the microstructure 210 from which it radiates, an adjacent or proximately located microstructure 210, or other nanostructures 220 within the nanocomposite structure 200.

In some embodiments, the nanocomposite materials systems can resemble the structure of a bird nest that is made from natural fibers and thin tree branches (i.e., with improved interface atomic scale bonding with mud, here as the resin system) with various thicknesses that are highly entangled and mechanically interlocked together and embedded in mud. Depending on the choice of nano-reinforcement and micro-reinforcement phases, such a nanocomposite material system can provide superior mechanical, electrical, thermal, magnetic, and optical properties in the thickness (i.e., transverse) and all other directions, regardless of the electrical and thermal characteristics of the resin system. Furthermore, due to highly entangled fibrous nature of the reinforcement phases that have improved atomic bonding with the host resin, such a material system is expected to have extraordinary penetration and impact resistance, when it is subjected to impact loads or hit by high velocity objects. It should also be understood that the proposed three-dimensional nanocomposite materials system will have a wide range of applications and can be used wherever high-performance light-weight materials are needed.

Nanostructures of the nanocomposites provided herein can include three-dimensional, high-aspect-ratio nanomaterials, for example, helical CNTs. The nanostructures are located in between the laminae and individual fiber strands within the fiber bundles/tows/yarn such that nanostructures are mechanically entangled with other nanostructures and the microstructures (e.g., fibers) within the microstructure groups (e.g., fiber strands). Since nanostructures are introduced in between the individual fiber strands within the fiber bundles/tows/yarns that make up the reinforcing fabrics, as well as in between the lamiae, both the interlaminar properties (properties between the laminae) and inter-fiber properties within the fiber bundles/tows/yarn will be improved due to the presence of nanoscale reinforcements therein. The nanostructures, when entangled and interlocked with each other and the fiber reinforcements, create a continuous network of highly reinforced fibrous mat that can be used to fabricate high-performance nanocomposites. These types of nanostructures provide superior properties and flexibility as well as excellent interlaminar reinforcement in a transverse direction within the composite structure that enhances the multifunctionality of the structure.

Certain embodiments of the nanocomposites provided herein can provide superior materials properties, such as mechanical properties, thermal properties, electrical properties, magnetic properties, and other physical properties, due to the presence of high-aspect ratio nanostructures (e.g., helical nanotubes) that are highly entangled and mechanically interlocked with each other and the microstructures contained within the nanocomposite. For example, in some embodiments, the nanostructure reinforcements within a nanocomposite can significantly improve the load transfer capability of the resin matrix. In some embodiments, the nanostructure reinforcements can provide the nanocomposite structure with structural load support. In some embodiments, the nanostructure reinforcements can provide the nanocomposite structure with efficient heat transfer and electrical conductivity properties.

Nanocomposite structures provided herein are applicable to a wide range applications, such as applications where high-performance light-weight materials can be utilized. Composite structures provided herein can be applied to a wide range of applications that pertain to marine and submarine structures, space and aerospace structures, wind turbines, biomedical devices and sensors, electronics, MEMS and NEMS, sporting goods, automotive industry, building materials, transportation industry, piping, and materials storage applications. Composite structures provided herein can be applicable to the space and aerospace, marine and submarine, automotive, sport, medical, electronic, oil and gas, and renewable energy related industries.

In some embodiments, various microstructure forms can be included in the nanocomposites provided herein. Exemplary forms of microstructures can include fibers or tubes. A group of microstructures can be grouped together to form a microscale strand (e.g., fiber strand), such as a bundle, a tow, or a yarn.

Suitable diameters of the microscale strands that are used as reinforcements can range from about 1 to about 100 micrometers, or microns (e.g., from about 1 microns to about 5 microns, from about 5 microns to about 10 microns, from about 10 microns to about 20 microns, from about 20 microns to about 30 microns, from about 30 microns to about 50 microns, from about 50 microns to about 70 microns, or from about 70 microns to about 100 microns). Certain embodiments of the nanocomposites provided herein can include microstructures of various thicknesses or diameters (between 1 and 100 microns) that are highly entangled and mechanically interlocked together in the nanocomposite structure.

The microstructures can include one or more polymeric, metallic, and ceramic materials. Exemplary materials for the microstructures provided herein can include carbon, an aramid (e.g., a para-aramid synthetic material), glass, silicon carbide, aluminum oxide, boron, aluminum, etc. in various forms (e.g., dry, pre-impregnated, continuous, short, long, chopped, aligned, or randomly oriented).

Nanocomposite structures can include multiple microstructures containing the same material, form and/or configuration. For example, the composite structure can include microstructures that contain a single fiber material. In some embodiments, composite structures can include a combination of different materials, forms, and/or configurations. For example, the composite structure can include any hybrid microstructure forms that include two or more types for fibers. In some embodiments, the composite structure includes at least two different types of microstructures in a laminated or a sandwich configuration for high-performance applications.

Microstructure groupings (e.g., strands) can be arranged in various configurations (e.g., see FIGS. 3A-3K). As mentioned above, a group of microstructures (e.g., fibers) can be formed into a fiber stand. A fiber strand can include a plurality of microfibers grouped in a bundle, a tow, or yarn form, in which thousands of fiber strands twisted together or bundled side-by-side. The fiber stands can be woven together to create fabrics with different textures and composition or put together side-by-side to create unidirectional mat and tapes. In the various forms above, the nanomaterials reinforcements can assembled and positioned in between the fiber filaments within the fiber tows/bundles/yarns and within the woven fabrics or unidirectional/bidirectional tapes and mats. In some embodiments, a nanocomposite materials system described herein can be used in conjunction with traditional polymeric, metallic, and ceramic microfiber reinforcements (e.g., carbon, aramid, glass, silicon carbide, aluminum oxide, boron, aluminum, etc.) in various forms (e.g., dry or prepreg, continuous short and long, chopped, aligned, randomly oriented, etc.) configurations (e.g., fiber tows, bundles, unidirectional tapes, woven fabrics, non-woven mat, non-crimp fabrics, three-dimensional braded fabrics, non-woven non-crimp two-dimensional stitched fabrics, non-woven non-crimp three-dimensional fabrics, and any other architecture), and combinations (e.g., single fiber material or any hybrid forms that include two or more types for fibers). Such structures using certain embodiments of the nanocomposite materials systems described herein in combination with one or more other materials can provide various types of composites (e.g., laminated and sandwich) for high-performance applications. In some embodiments, resin system can be involved, including, without limitation polymeric, metallic, and ceramic matrices in their pristine, chemically modified, and or reinforced form with primary nanomaterial inclusion (e.g., the resin that has been already reinforced with primary nanomaterials that have geometry configurations other than helical coils).

In some embodiments, e.g., for highly entangled mechanically interlocked chemically functionalized nanoscale reinforcement phase, various types of nanomaterials (e.g., carbon based, boron nitride, silicon, silicon carbide, silver, platinum, silver-gallium, other metals, metal oxides, and other ceramic and polymeric fibers) can be used in helical coil-like structural configurations (e.g., helical carbon nanotubes and carbon nanofibers).

FIGS. 3A-3K show exemplary groups of microstructures that can be used in the composite structures provided herein. FIG. 3A shows glass, Kevlar, and carbon fiber tows. FIGS. 3B and 3C show unidirectional carbon fiber tapes with and without stitching, respectively. FIGS. 3D-3F show carbon and Kevlar woven fabrics with different textures. FIGS. 3G and 3H show glass-carbon and glass-carbon-Kevlar hybrid woven fabrics, respectively. FIG. 3I shows a braided biaxial sleeve. FIGS. 3J and 3K show carbon and glass fibers, respectively, that are randomly oriented to form a continuous mat.

In some embodiments, interlocking nanostructures are provided. Interlocking nanostructures can include structures of various forms and configurations having a high-aspect-ratio. Interlocking nanomaterials can include a variety of suitable materials, including metals, ceramics, polymers, and combinations thereof Exemplary suitable materials include carbon, boron nitride, silicon, silicon carbide, silver-gallium, platinum, silver, metal oxides, and combinations thereof.

The interlocking nanostructures can include various structural configurations. Exemplary structural configurations include nanowires, nano-rods, nano-sheets, nano-ribbons, nano-clay platelets, single- or double-, or multi-walled nanotubes, straight nanotubes, helical nanotubes, and combinations thereof. In some embodiments, the interlocking nanostructures includes a configuration having a high-aspect-ratio. For example, the nanostructure can includes a body configured to enhance entanglement and mechanical interlocking. In some embodiments, the interlocking nanostructure can include a body defined with one or more curvatures, or a body that extends along a curvilinear axis (e.g., a helical body).

In various embodiments, interlocking structures are carbon nanostructures. Owing to their remarkable properties, carbon nanostructures are suitable materials for providing nanoscale reinforcements in the through-the-thickness direction. Carbon nanomaterials can be synthesized/produced in various forms and configurations (e.g., buckyballs, graphene, single- or double-, or multi-walled straight, and helical nanotubes), which may have different properties and characteristics that make them unique for certain engineering, medical, and cosmetic applications. The remarkable mechanical properties (e.g., high strength, flexibility, and high modulus), thermal and electrical conductivities, electromagnetic, and optical properties are some of the unique characteristics of carbon nanotubes (CNTs).

Nanostructures can have diameters (or widths) ranging from about 1 nm to about 100 nm. In some embodiments, nanostructures have diameters (or widths) ranging from about 1 nm to about 10 nm, from about 10 nm to about 20 nm, from about 20 nm to about 30 nm, from about 30 nm to about 40 nm, from about 40 nm to about 50 nm, from about 50 nm to about 100 nm, from about 10 nm to about 100 nm, from about 10 nm to about 50 nm, or from about 10 nm to about 25 nm. Certain embodiments of the composite system provided herein can include nanostructures of various thicknesses that are highly entangled and mechanically interlocked together in the nanocomposite.

Nanostructures can have a range of suitable lengths that form an elongate nanostructure. For example, suitable length dimensions for nanostructures can be a length that is greater than 2 microns, or a length less than 3,000 microns (3 mm). In some embodiments, suitable length dimensions of nanostructures can range from 2 microns to about 10 microns, from about 10 microns to about 50 microns, from about 50 microns to about 100 microns, from about 100 microns to about 500 microns, from about 500 microns to about 1000 microns, from about 1000 microns to about 2000 microns, or from about 2000 microns to about 3000 microns.

Certain embodiments of nanostructures can include a plurality of helical nanotubes (which can also be referred to as “nano-heli-coils” (NHCs)). The helical nanotubes or NHCs can be composed of carbon (e.g., helical carbon nanotubes (HCNTs) or “carbon nano-heli-coils” (CNHCs)). Helical carbon nanotubes (HCNTs) are generally longer CNTs formed into a spring-like shapes. Due to the combination of their unique helical spring-like structural shapes and exceptional properties, HCNTs hold great potential for a range of applications including catalyst supports, electrode materials, micro- and nano-electromechanical devices and sensors, photoconductive materials, and structural nanocomposites. For a specific application (e.g., structural nanocomposites), the performance of and efficiency of the material system can be considerably affected by the geometrical characteristics of the HCNTs, e.g., the coil diameter, pitch of the coil, and diameter of the coil wire. Due to the ability to stretch and compress like a coil spring, the HCNTs finds greater application for carrying mechanical loads in both static and dynamic modes, thus, HCNTs will be of great use in high-performance structures subjected to complex loading conditions. Compared to the straight CNTs, the unique geometrical configurations of the HCNTs provide higher flexibility both in tension and compression and can absorb more energy. The HCNTs have a spring-like effect that will undergo large deformation and can sustain extremely large strains.

In some embodiments, the nanostructure can include at least a portion of the plurality of carbon tubes that are straight carbon tubes and a portion of the plurality of carbon that are helical carbon tubes. A ratio of straight carbon tubes to helical carbon tubes can range from about 10:90 to about 90:10, in some embodiments.

FIGS. 4A-4D show scanning electron micrographs (SEM) images of exemplary interlocking nanostructures. FIGS. 4A and 4B show entangled and interlocked bundles of coiled and straight carbon nanotubes having a coil diameter of about 10 μm to about 100 μm (see arrow depictions in figures). FIGS. 4C and 4D show individual carbon nanotube coils having a coil diameter of about 100 nm to about 1 μm (see arrow depictions in figures).

The coiled nanostructures can have an average coiled diameter ranging from about 50 nm to about 500 nm, from about 100 nm to about 300 nm, or from about 200 to about 300 nm. In some embodiments, the helical nanostructures include nanostructures having diameters ranging from about 50 nm to about 100 nm, from about 100 nm to about 200 nm, from about 200 nm to about 300 nm, from about 300 nm to about 400 nm, from about 400 nm to about 500 nm, from about 50 nm to about 400 nm, from about 75 nm to about 350 nm, from about 100 nm to about 300 nm, or from about 50 nm to about 300 nm. In some embodiments, the composite system provided herein can include nanostructures having a range of coil diameters.

In some embodiments, 3D reinforced nanocomposites using high density arrays of vertically aligned CNTs, directly grown on various types of fabrics can be used as interlocking structures. Such structures can improve fracture toughness, flexural modulus and strength, flexural toughness, damping, coefficient of thermal expansion (CTE), through-the-thickness thermal and electrical conductivities of the composite structure. In some embodiments, vertically aligned high density arrays of CNT nanoforests can be applied to improve interlaminar shear strength of the composite structure. In some embodiments, CNT nanoforests can be arranged in a direction normal to laminae within the composite structure.

In some embodiments, the nanostructures provided herein can include functionalized carbon nanostructures, for example, as described in U.S. Pat. Publication No. 2006/0093885, which has been incorporated in its entirely

Depending on the choice of nano- and micro-reinforcements, various embodiments of the nanocomposites provided herein can provide superior mechanical, electrical, thermal, magnetic, and optical properties in the thickness (i.e., transverse) direction, regardless of the electrical and thermal characteristics of the resin of the nanocomposite. Due to highly entangled fibrous nature of the reinforcement phases, the nanocomposites provided herein can have a desirable penetration and impact resistance under a high impact load or an impact from high velocity objects.

In some embodiments the high-performance nanocomposite materials systems described herein can be fabricated (e.g., thin layers of high-aspect-ratio helical nanomaterials and mono-fiber-thick layers of microfiber reinforcements will be assembled on top of and in between each other), layer-by-layer, being highly entangled and mechanically interlocked together, until the desired thickness is obtained. The interlayered stacks of microfiber-nanomaterials laminae can be impregnated with a resin system (that could have also been reinforced with chemically functionalized HCNTs) and then either B-staged and stored, or used directly to manufacture highly-reinforced nanocomposite materials and structures for high-performance applications.

In some embodiments, high-aspect-ratio nanomaterials (e.g., helical CNTs) can be formed in between the laminae and individual fiber strands within the fiber bundles/tows/yarn that are mechanically entangled together and the fiber strands at room temperature. In some embodiments, CNT nanostructures can be grown on various fiber bundles and fabrics at elevated temperatures (e.g., 770° C.).

The control of growth mechanism and growth parameters are important in synthesizing CNTs with various structures and configurations. Chemical Vapor Deposition (CVD) can be a method used to produce CNTs with various structural configurations, architectures and patterns on various types of substrates. The produced CNTs in this method can depend on different parameters such as: type and feed rate of the carbon source; the type, shape, and size of the catalysts; the type and flow rate of the carrier gas; the materials, geometry, morphology of the substrate; reaction temperature at the substrate location inside the CVD system; substrate orientation with respect to the carrier gas flow; and size of the CVD system. In general, in a CVD system the CNTs grow perpendicular to the surface of substrate that is placed inside a high temperature furnace.

This proposed method provided herein can easily be scaled up to produce nanocomposite material systems in large quantities that are highly reliable and reproducible.

In some embodiments, the nanostructures or nanocomposite materials can be chemically functionalized. One benefit of chemical functionalization of HCNTs is to improve their dispersion and interface atomic bonding with the molecules of the host resin system used for fabrication of traditional composite materials.

In some embodiments, a method of functionalizing the nanomaterials can include Method 1, reflux with nitric acid. Reflux time can range from about 1 hour to about 48 hours, for example, 2-4 hours, 5-7 hours, 20-30 hours, about 3 hours, about 6 hours, or about 24 hours. In some embodiments, the reflux can occur at a temperature of between about 50° C. and about 150° C., for example, 50-70° C., 90-110° C., about 60° C., or about 100° C. Various concentrations of nitric acid can be used. In some embodiments, the nitric acid can have a molarity of between about 1 M and about 20 M, for example, about 3 M, about 5 M, about 8 M, or about 16 M.

In some embodiments, a method of functionalizing the nanomaterials can include Method 2, sonicating with nitric and sulfuric acids. Sonication time can range from about 1 hour to about 48 hours, for example, 2-4 hours, 5-7 hours, 8-10 hours, 20-30 hours, about 3 hours, about 6 hours, about 9 hours, or about 24 hours. Various concentrations can be used for either acid. In some embodiments, the nitric acid or sulfuric acid can have a molarity of between about 1 M and about 20 M, for example, about 3 M, about 5 M, about 8 M, or about 16 M. Various ratios of sulfuric acid:nitric acid can be used. In some embodiments, the ratio of sulfuric acid:nitric acid can range from 1:1 to 3:1.

In some cases, high-aspect-ratio nanomaterials (e.g., helical CNTs) can be placed in between the laminae and individual fiber strands within the fiber bundles/tows/yarn that are mechanically entangled together and the fiber strands, all at room temperature. The nanomaterials (e.g., CNTs) can be entangled-interlocked with each other and the fiber reinforcements, creating a continuous network of highly reinforced fibrous mat that can be used to fabricate high-performance multifunctional nanocomposites. In addition, helical CNTs (“HCNTs”) can be incorporated within the resin system as well. The presence of highly entangled network of HCNTs that are interlocked with each other and stuck inside the resin system can further improve properties of resin systems, in addition to the entanglement and interlocking of HCNTs with the microfiber reinforcements. Because of their helical configurations, HCNTs cannot be easily pulled out of the solidified resin. These CNTs with their superior properties and flexibility provide excellent interlaminar reinforcement in transverse and all other directions, and enhance the multifunctionality of laminated composite materials.

However, their effectiveness can, in some embodiments, depend on their interaction (i.e., interface bonding) with the resin molecules. In some embodiments, optimal amounts of effectively functionalized HCNTs can be included (using chemical routes and processes that were tuned for improvement of the HCNTs interface bonding with resin molecules) in between the laminae and individual fiber strands within the fiber bundles/tows/yarn that are mechanically entangled together and the fiber strands, all at room temperature. The functionalized HCNTs (FHCNTs) can have improved atomic bonding within the resin system and they will be entangled/interlocked with each other and the fiber reinforcements, creating a continuous network of highly reinforced fibrous mat that can be used to fabricate high-performance nanocomposites. These chemically functionalized HCNTs with their superior properties and flexibility provide excellent interlaminar reinforcement in transverse and all other directions and enhance the performance and multifunctionality of laminated composite materials. Various Methods and techniques can be used for the incorporation of carbon nanotubes (i.e., with straight and helical configurations in pristine and/or functionalized forms) over and in between the fiber strands that compose the fiber bundles/tows/yarn and laminae. For example, electrically charged (e.g., positive charge) FHCNTs (in powder form and/or suspended in DI water in liquid form) can be sprayed inside a chamber, where electrically charged (i.e., with opposite charge, e.g., negative) microfibers (i.e., carbon, glass, Kevlar, silicon carbide, etc.) is passing through in spread and individually separated form. The positively charged functionalized HCNTs will be attracted and deposited over and around the negatively charged separated/suspended individual fiber strands and they can be collected/grouped and bundled together in form of fiber bundles/tows/yarns and or unidirectional tapes. As a result, theses fiber bundles/tows/yarns and or unidirectional tapes can include FHCNTs that are effectively incorporated over and in between all the fiber filaments. As another example, the FHCNTs can be suspended and dispersed very uniformly in DI water (i.e., as a results of chemical functionalization).

Next, the traditional microfibers (i.e., carbon, glass, Kevlar, silicon carbide, etc.) can pass through the FHCNTs-DI water solution in spread and individually separated form. The FHCNTs can be deposited and collected over and around the separated/suspended individual fiber strands and then they can be collected/grouped and bundled together in form of fiber bundles/tows/yarns and or unidirectional tapes. As a result, theses fiber bundles/tows/yarns and or unidirectional tapes can include FHCNTs that are effectively incorporated over and in between all the fiber filaments. Later, these microfiber bundles/tows/yarns that were deposited with CNTs (i.e., straight and helical configurations in pristine or chemically functionalized forms) in dry form or preimpregnated (impregnated with a rein system and B-staged, once they are dried after passing through the FHCNTs-DI water bath) can be used to weave dry fabrics and/or prepregs with unidirectional and bi-axial architectures. The FHCNTs incorporated fabrics and unidirectional tapes can be used to fabricate high-performance multifunctional nanocomposites.

Some embodiments can include, without limitation:
Embodiment 1 is a nanocomposite structure comprising:
   a first microfiber;
   a second microfiber; and
   a plurality of nanostructures coupling the first and second microfibers together, wherein the plurality of nanostructures comprise helical tubes.
Embodiment 2 is a nanocomposite structure comprising:
   a first microfiber;
   a second microfiber; and
   a plurality of nanostructures coupling the first and second microfibers together, wherein the plurality of nanostructures comprise helical carbon tubes.
Embodiment 3 is the nanocomposite structure of Embodiment 1, wherein plurality of nanostructures comprises chemically functionalized nanostructures.
Embodiment 4 is the nanocomposite structure of Embodiment 1, wherein the helical tubes are selected from the group consisting of helical carbon tubes, chemically functionalized helical carbon tubes, and combinations thereof.
Embodiment 5 is the nanocomposite structure of any one of Embodiments 1-4, wherein at least a portion of the plurality of nanostructures couple with the first fiber and adjacent nanostructures.
Embodiment 6 is the nanocomposite structure of any one of Embodiments 1-5, wherein the nanostructures are selected from the group consisting of carbon, boron nitride, silicon, silicon carbide, silver-gallium, platinum, silver, metal oxides, and combinations thereof.
Embodiment 7 is the nanocomposite structure of any one of Embodiments 1-6, wherein the nanostructures comprise carbon.
Embodiment 8 is the nanocomposite structure of any one of Embodiments 1-7, wherein the first microfiber, the second microfiber, or both, are selected from the group consisting of glass, a para-aramid synthetic fiber, carbon, silicon carbide, boron, aluminum oxide, or combinations thereof
Embodiment 9 is the nanocomposite structure of any one of Embodiments 1-8, wherein the nanostructures have an elongate body with a length of greater than 2 microns.
Embodiment 10 is the nanocomposite structure of any one of Embodiments 1-9, wherein the nanostructures have an elongate body with a length ranging from about 10 microns to about 50 microns, from about 50 microns to about 100 microns, from about 100 microns to about 500 microns, from about 500 microns to about 1000 microns, or from about 1000 microns to about 10000 microns.
Embodiment 11 is the nanocomposite structure of any one of Embodiments 1-10, wherein an amount of nanostructures ranges from about 0.02% to about 1% by weight of the nanocomposite.
Embodiment 12 is the nanocomposite structure of any one of Embodiments 1-11, wherein an amount of the nanostructures is less than 1% by weight of the nanocomposite.
Embodiment 13 is the nanocomposite structure of any one of Embodiments 1-12, wherein an amount of the nanostructures is less than 0.5% by weight of the nanocomposite.
Embodiment 14 is the nanocomposite structure of one of Embodiments 1-13, wherein an amount of the nanostructures is less than 0.2% by weight of the nanocomposite.
Embodiment 15 is the nanocomposite structure of any one of Embodiments 1-11, wherein an amount of microstructures ranges from about 10% to about 70 by weight of the nanocomposite.
Embodiment 16 is the nanocomposite structure of any one of Embodiments 1-15, further comprising a resin matrix in which the first microfiber, the second microfiber, and the plurality of nanostructures are embedded uniformly therein.
Embodiment 17 is the nanocomposite structure of Embodiment 16, wherein the resin matrix comprises an epoxy polymer.
Embodiment 18 is the nanocomposite structure of any one of Embodiments 1-17, wherein the first and second microfibers are comprised within a bundle, tow, or yarn of microfibers that are coupled together by the plurality of nanostructures within the nanocomposite structure.
Embodiment 19 is the nanocomposite structure of any one of Embodiments 1-18, wherein each helical tube has a tube diameter of about 1 nm to about 100 nm.
Embodiment 20 is the nanocomposite structure of any one of Embodiments 1-19, wherein each helical nanostructure has a coil diameter of about 50 nm to about 500 nm, from about 100 nm to about 300 nm, or from about 200 to about 300 nm.
Embodiment 21 is the nanocomposite structure of any one of Embodiments 1-20, wherein the nanocomposite structure comprises a plurality of microfibers.
Embodiment 22 is a method of forming the nanocomposite structure of any one of Embodiments 1 or 2, the method comprising using a chemical vapor deposition system to vaporize a precursor-catalyst solution to form nanostructures on a substrate, wherein the nanostructures are helical carbon nanotubes, and wherein the substrate comprises a glass fiber foam including a plurality of randomly oriented glass fibers.
Embodiment 23 is a nanocomposite structure comprising:
   a first microfiber;
   a second microfiber; and
   a plurality of chemically functionalized helical nanostructures coupling the first and second microfibers, and the plurality of nanostructures comprise helical carbon tubes.
Embodiment 24 is the nanocomposite structure of Embodiment 1, wherein at least a portion of the plurality of chemically functionalized helical nanostructures couple with the first fiber and adjacent nanostructures.
Embodiment 25 is the nanocomposite structure of any one of Embodiments 23-24, wherein the chemically functionalized helical nanostructures are selected from the group consisting of carbon, boron nitride, silicon, silicon carbide, silver-gallium, platinum, silver, metal oxides, and combinations thereof.
Embodiment 26 is the nanocomposite structure of any one of Embodiments 23-25, wherein the chemically functionalized helical nanostructures comprise carbon.
Embodiment 27 is the nanocomposite structure of any one of Embodiments 23-26, wherein the first microfiber, the second microfiber, or both, are selected from the group consisting of glass, a para-aramid synthetic fiber, carbon, silicon carbide, boron, aluminum oxide, or combinations thereof.
Embodiment 28 is the nanocomposite structure of any one of Embodiments 23-27, wherein the chemically functionalized helical nanostructures have an elongate body with a length of greater than 2 microns.
Embodiment 29 is the nanocomposite structure of any one of Embodiments 23-27, wherein the chemically functionalized helical nanostructures have an elongate body with a length ranging from about 10 microns to about 50 microns, from about 50 microns to about 100 microns, from about 100 microns to about 500 microns, from about 500 microns to about 1000 microns, or from about 1000 microns to about 10000 microns.
Embodiment 30 is the nanocomposite structure of any one of Embodiments 23-29, wherein an amount of chemically functionalized helical nanostructures ranges from about 0.02% to about 1% by weight of the nanocomposite.
Embodiment 31 is the nanocomposite structure of any one of Embodiments 23-30, wherein an amount of the chemically functionalized helical nanostructures is less than 1% by weight of the nanocomposite.
Embodiment 32 is the nanocomposite structure of any one of Embodiments 23-31, wherein an amount of the chemically functionalized helical nanostructures is less than 0.5% by weight of the nanocomposite.
Embodiment 33 is the nanocomposite structure of any one of Embodiments 23-32, wherein an amount of the chemically functionalized helical nanostructures is less than 0.2% by weight of the nanocomposite.
Embodiment 34 is the nanocomposite structure of any one of Embodiments 23-30, wherein an amount of microstructures ranges from about 10% to about 70 by weight of the nanocomposite.
Embodiment 35 is the nanocomposite structure of any one of Embodiments 23-34, further comprising a resin matrix in which the first microfiber, the second microfiber, and the plurality of chemically functionalized helical nanostructures are embedded uniformly therein.
Embodiment 36 is the nanocomposite structure of Embodiment 35, wherein the resin matrix comprises an epoxy polymer.
Embodiment 37 is the nanocomposite structure of any one of Embodiments 23-36, wherein the first and second microfibers are comprised within a bundle, tow, or yarn of microfibers that are coupled together by the plurality of chemically functionalized helical nanostructures within the nanocomposite structure.
Embodiment 38 is the nanocomposite structure of any one of Embodiments 23-37, wherein each helical tube has a tube diameter of about 1 nm to about 100 nm.
Embodiment 39 is the nanocomposite structure of any one of Embodiments 23-38, wherein each chemically functionalized helical nanostructure has a coil diameter of about 50 nm to about 500 nm, from about 100 nm to about 300 nm, or from about 200 to about 300 nm.
Embodiment 40 is the nanocomposite structure of any one of Embodiments 23-39, wherein the nanocomposite structure comprises a plurality of microfibers.

### EXAMPLES

The invention is further described in the following examples, which do not limit the scope of the invention described in the claims.

### Example 1: Helical Carbon Nanotubes Formation by Chemical Vapor Deposition

### 1.1 Method of CNT Fabrication

Helical CNTs were formed by using chemical vapor deposition (CVD) as discussed herein in the subsequent sections. CVD technique was used, due to its simplicity and ability for substantial control over the influential growth parameters such as: CNTs length, alignment, and pattern of growth.

FIG. 5 shows a 3D schematic of the CVD system with detailed components used for growing helical CNTs in this example. The system included a high temperature tube furnace as a reactor; a quartz tube (i.e., 2-6 in diameter); a substrate (i.e., glass fiber foam comprised of chopped glass fibers of 1-10 micron diameter randomly oriented and densely packed together) placed inside the quartz tube (at 770-800° C.); a syringe pump for injection (at 0.125 cc/min) of a mixture of precursor-catalyst solution (i.e., 1 gram Ferrocene mixed with 100 ml of Xylene); a pre-heater to vaporize the precursor-catalyst mixture (at 180-190° C.); a gas flow meter or a mass flow control to control the inert carrier gas flow rate (at 30-60 CC/min) that carries the precursor-catalyst vapor into the reaction zone inside the quartz tube; and the argon-hydrogen gas tank (i.e., contains 90% Ar+10% H2) to provide and maintain inert atmosphere inside the quartz tube during the CVD process.

Growth parameters such as carrier gas flow rate, furnace temperature, pre-heater temperature, substrate, location of the substrate inside the quartz tube, and precursor-catalyst solution injection rate that are listed above were obtained through a set of systematic parametric studies and were optimized for the growth of helical CNTs in this experiment. A very small change in each of these parameters can result in miss-functioning of the reactor and the growth of carbon nanotubes may be halted or other end product may not contain helical CNTs. This is a very sensitive process and all the steps and processes should be handled very carefully, precisely, and consistently; otherwise, no carbon nanotubes are obtained. Note that all the growth parameters listed above are obtained for the system in this example and thus may change for a different set-up and/or systems.

For growth of helical CNTs, first, a special type of substrate (i.e., glass fiber foam composed of randomly oriented and densely packed chopped glass fibers of 1-10 micron diameter), on which helical CNTs were deposited and grown, was put in a high-temperature fused ceramic tray and then placed inside the quartz tube within the growth zone (almost middle of the heating zone). The syringe was loaded with precursor-catalyst solution (e.g., Ferrocene nanoparticles mixed Xylene) and the syringe pump was set for an optimum solution feeding rate that was to be injected to the pre-heating zone.

After closing and sealing the end-caps of the quartz tube, inert gas (e.g., mixture of argon-hydrogen) was allowed inside the quartz tube with a higher flow rate (for few minutes) to get rid of the trapped air inside the tube furnace, and then the high temperature furnace was turned on. When the temperature of furnace reached ˜400° C., the inert gas flow rate was reduced to the optimum flow rate (e.g., 30-60 CC/min) at which the growth of helical CNTs was to occur. At the same time, the pre-heater was switched on to reach the evaporation temperature of the precursor-catalyst solution (i.e., 180-190° C. for Ferrocene-Xylene mixture).

Once the pre-heater and the quartz tube furnace reached their set temperatures (e.g., 180-190° C. and 770° C. for our CVD, respectively) the precursor-catalyst solution that was prepared by sonication mixing of approximately 1 gram of Ferrocene (98%, obtained from Sigma Aldrich) dissolved in 100 ml of Xylene (98.5%, obtained Fisher Scientific) was fed continuously at an optimum feeding rate (i.e., 0.12 CC/min) into the two-stage tubular quartz reactor using the syringe pump. The liquid feed was passed through a capillary sample cylinder tube and pre-heated to approximately 180° C. prior to its entry into the quartz tube furnace. At this temperature, the precursor solution exiting the capillary was immediately vaporized and swept into the reaction zone of the furnace by a flow of argon-hydrogen carrier gas. The inner diameter and the length of the quartz tube were approximately 50 mm and 1 m, respectively.

In the growth zone at the presence of glass foam substrate, the precursor was decomposed and then reactive atomic carbons diffuse and dissolve into the catalyst particles seating on the substrate and after reaching super-saturation, they precipitate out forming arrays of entangled helical CNTs over and in between the glass fibers of the substrate. Depending on the required length for CNTs, the CVD reaction time was set to run for approximately 30 minutes for ˜0.5 mm long helical CNTs growth.

Finally, the pre-heater and the furnace were turned off and allowed to cool down to room temperature, while argon-hydrogen gas was still flowing, after which the helical CNTs were retracted from the quartz tube.

### 1.2 Experimental Results

Using the CVD system described above, helical CNTs were successfully grown on glass foam substrates, which can be separated as a standalone high density helical CNTs foam/medium for various engineering, medical, and cosmetic applications.

FIGS. 6A-6B and 7A-7C show various magnifications of the scanning electron micrographs (SEM) of nanoscale helical CNTs with different geometrical configurations that were grown on and in between the microscale glass microfibers that compose the glass foam substrates, used in our CVD growth process. The diameter of CNTs forming the coils were approximately 20-50 nm (i.e., coil wire); the coil-diameter ranged from 150 nm to 800 nm; the coil-pitch ranged from 150 nm to 1000 nm; and the CNT coils' lengths were more than few hundred microns and possibly up to few millimeters (as best shown in FIG. 6B).

As a result, the use of foam-like glass substrate, made of super fine short glass fibers, yielded helical CNTs with various pitches and coil diameters. These helical CNT networks are highly entangled, creating a mechanically interlocked fibrous mat that is highly porous, very strong, highly flexible, and electrically/thermally conductive. The CNT networks provide a very large effective surface area per unit volume that are extremely light and multifunctional. The helical CNTs that are grown on glass foam substrates can be separated from glass foam substrates (i.e., using solvents and chemicals such as diluted hydrofluoric acids that can dissolve glass) and then directly (with or without subsequent chemical or physical functionalization) included into various host materials (e.g., polymeric, ceramic, and metallic matrices used in composite industries) and/or placed and/or intertwined/entangled with various types (i.e., all types of polymeric, ceramic and metallic or any combinations) and architectural configurations (e.g., chopped fiber randomly oriented or aligned, unidirectional continuous, 2D and 3D woven, 2D and 3D non-woven and non-crimp, and 2D randomly oriented continuous fiber mat and vails) of microfiber reinforcements that are commonly used in high-performance laminated composite materials to further enhance their properties and performances.

In addition, due to helical CNT characteristics (e.g., superior properties, geometries, and effective surface area per unit volume), helical CNTs can be incorporated in high performance MEMS and NEMS devices and systems to provide mechanical structural integrity, higher heat dissipation rate, higher chemical absorption or reaction rate, selective and nanoscale filtrations, and magnetic inductions. Furthermore, high-density mechanically entangled helical CNTs medium are very light and compliant and can be used as multifunctional foam core materials to fabricate high-performance sandwich structures with high-impact resistance. Optimization or tune-up of the growth parameters to synthesize helical CNTs in mat or carpet achieves different densities and entanglement levels for various customized applications

### Example 2: Evaluate Effects of Carbon Nanotubes' Helical Geometries and Loading Concentrations on Mechanical Properties of Nanocomposites

### 2.1 Experimental Setup and Testing

Epoxy polymer and carbon nanotubes (i.e., straight and helical geometries) were used as the matrix and the reinforcement to fabricate nanocomposite samples, respectively. Different weight percentages of straight multi-wall carbon nanotubes (MWCNTs) and helical carbon nanotubes (HCNTs) were dispersed in the polymer matrix to fabricate the nanocomposites.

FIG. 8 schematically shows the steps that were used to fabricated/process the nanocomposite samples. Sets of the panels were fabricated by casting methods for testing based on the American Society for Testing and Materials (ASTM) standards. The pristine samples with no nano-inclusion were also fabricated as reference samples that were compared with those with nano-inclusion.

In general, 168 grams of epoxy containing 152 grams of resin part “A” and 31 grams of part “B” was used to fabricate panels with the desired thickness. First, CNTs were weighted and placed inside a small beaker and then ethyl alcohol was added. The beaker covered with a layer of parafilm and then it was sonicated for 15 min. After a 10-min break, the sonication process was repeated for 15 minutes again and then the solution of ethanol and CNTs were added to a glass beaker that contained the Epoxy resin part “A” (i.e., EPON 815C, obtained from Momentive). The mixture of CNTs, ethanol and Epoxy was stirred and heated at 70° C. for several hours. The container was weighted in different intervals to ensure that the ethyl alcohol is completely evaporated.

After the removal of the solution from the epoxy, the beaker was placed on the magnetic stirrer (with no heating) to cool down the epoxy and nanotubes to room temperature. Cooling down is an important factor, since mixing the hardener and epoxy in high temperature may lead to an immediate reaction and as a result the premature solidification of the epoxy system. It also helps to improve the dispersion and reduce the bubbles.

A specific amount of this mixture of CNTs and Epoxy was poured in a bigger beaker and the required amount of hardener (EPIKURE 3282 obtained from Momentive) was added to it. This mixture was mixed slowly by a small glass rod for 10 min and was poured into the mold and cured in the room temperature for 8 hrs before being removed from the mold.

After removal, the panels are post-cured in an oven for 2 hours at a constant temperature of 121° C. in a furnace. The post-curing process is carried out to complete the polymerization process of the epoxy hardener mixture, according to the manufacturer.

Next, the nanocomposite panels were removed from the mold and then cut into required sizes and geometries using a diamond tile cutter, a CNC milling machine, a custom built fixture, and a cutoff wheel. FIGS. 10A-10B show the detailed geometries and the dimensions of the Tensile and the Fracture Toughness test specimens. After the machining of a notch on the fracture toughness test samples, a sharp blade with a v-tip was used to cut the small sharp cracks.

Nanocomposite samples were cut into 50 mm×50 mm for dielectric constant measurements. For thermal conductivity measurements, nanocomposite samples were machined down to 1.0 mm-1.5 mm thickness and later cut into 10 mm×10 mm samples on a Band saw.

### Tensile Testing

ASTM D638 was used to measure the tensile strength, Young's modulus, and strain-to-failure of the nanocomposite samples. The width and thickness of each sample was measured to calculate the cross-sectional area at the center of the gage length. The samples (see FIGS. 11A-11B) after machining are checked for any burrs and examined for machining defects.

A MTS Criterion 45 was used with a pair of gripping jaw fixture for tensile testing and the speed of the test for all the samples was maintained at 1 mm/min. An extensometer was used to accurately measure the strain values. All the samples were wrapped properly from the grip area with sandpaper to avoid the end crushing and slipping off the samples out of the grips while the load is directly acting on the samples. The tensile strength (MPa), Young's Modulus (MPa), and strain to failure (%) values were recorded and tabulated for each sample for analysis and comparison purposes. The readings from the samples with fractures within the grips were rejected.

### Fracture Toughness Testing

The ASTM 5045 test method involves loading a notched specimen (shown in FIG. 7) that has been pre-cracked in 3-point bending, also called Single-Edge Notch Bending (SNEB). The validity of the mode I plane strain fracture toughness (KIC) values greatly depends on the adequate dimensions of the specimen to give linear elastic behavior; hence, care is taken during the sample preparation. The sample dimensions are proportional to the thickness of the specimen out of the curing cycle. The thickness value of 3.4 mm used in this example and the dimensions of the specimen is shown in FIG. 10A.

The test samples were tested on a three-point bending fixture. For each set of samples, tensile strength (σy) values from tensile tests along with the sample dimensions and the maximum load (sustained by the specimen until fracture) were used to calculate KIC values.

After breaking each specimen the results were recalculated based on the actual crack length measured on a microscope. Later the results were examined for the dimensional criterion validation based on the suggestions from ASTM 5045, where the thickness, the crack length and the width minus the crack length should all be greater than 2.5 (KIC/σy)2. If any one of the criteria failed for a sample, that sample was rejected. The criterion were required because it ensures that there is a sufficient plane strain and it avoids any excessive plastic region while the load is being applied.

### Thermal Conductivity Testing

ASTM E1461 was used to measure the thermal conductivity of the nanocomposite samples. In general, for this test a small thin disc specimen was subjected to a high-intensity short duration radiant energy pulse; in this case, a laser was used. The energy of the pulse was absorbed on the front surface of the specimen and the resulting rear face temperature rise was recorded. Specific heat can be obtained by a comparative method, where two samples are measured subsequently under the same conditions: a test sample under investigation, and a reference sample with previously determined properties. By comparing the maximum temperatures obtained on both of the samples the Specific heat can be calculated. The test samples were machined to 1-1.5 mm thick and cut into 10 mm×10 mm (see FIG. 13), since the sample tray we used holds 10 mm×10 mm samples. For each CNTs concentration, 3 samples were prepared. The samples are then coated with dry graphite sprayed on both sides to increase the response to the xenon flash. The setup was run along with a reference sample with known properties at room temperature.

### Dielectric Constant Testing

ASTM D150 was used for the measurement of the Dielectric Constant for the nanocomposite samples. 1 kHz Capacitance Bridge along with aluminum disk electrodes of 1.5 in diameter (see) was used to measure the capacitance.

### 2.2 Results and Discussions

### Tensile Test Results

Epoxy polymer and carbon nanotubes (i.e., straight and helical geometries) were used as the matrix and the reinforcement, as mentioned earlier. The goal was to optimize performance of the epoxy materials system through incorporation of optimum amounts of CNTs with straight and helical configurations and employment of effective processing techniques.

The results obtained from the tensile testing includes the tensile strength, tensile modulus, and the strain at break, which are presented in Table 1. The strain at break was measured in terms of percentage change in the original gage length that was recorded using an extensometer. For all measurements, the standard deviation are calculated and the property changes were calculated in comparison to the pristine post cured epoxy samples. The driving factor to go for post curing was not only to maximize the curing time for the epoxy, but also to attain the maximum properties.

An initial comparison between the post-cured pristine epoxy without post curing showed ˜8% increase in the tensile strength, a ˜7% drop in tensile modulus, and interestingly ˜98% increase in the strain to break. This signifies the effectiveness of the post curing on mechanical property of the epoxy. The post curing improved the strain to failure almost by 100%, making it behave in a more ductile manner. The interaction between epoxy molecules and the CNTs paves the load transferred through CNTs and as a result, the tensile strength and the ductility of the nanocomposites are expected to improve. In a nutshell, the results presented in Table 1 show that maximum improvements of tensile strength (i.e., 13.21% and 12.96% highlighted in the Table 1) due to the incorporation of CNTs belongs to 0.1 wt % loading of straight CNTs and 0.05 wt % loading of Carbon NanoHeliCoils (CNHCs), respectively. As shown in the table, for most reinforced nanocomposite sample, the tensile modulus was somewhat reduced (i.e., no more than 6%).

Regarding the strain to failure, maximum improvements (i.e., 25.86% and 25.24% highlighted in the Table 1) due to the incorporation of CNTs belongs to the same 0.1 wt % loading of straight CNTs and 0.05 wt % loading of Carbon NanoHeliCoils (CNHCs), respectively. These results conclude that to obtain optimal tensile strength and ductility improvements, one can use 50% less CNHCs reinforcements, compared to the percentage loading of straight CNTs. In another note, the tensile strength and strain-to-failure of the nanocomposites samples that were reinforced with 0.05 wt % straight CNTs were improved by 4.43% and 15.19%, respectively (see Table 1). Comparison of these results to obtained for nanocomposite samples with 0.05 wt % helial CNTs reinforcements (i.e., 12.96% and 25.24% improvements in tensile strength and strain-to-failure), demonstrates that helical CNTs are more effective than straight CNTs.

TABLE 1
Tensile test results for post-cured nanocomposite samples
ASTM D638-10 Tensile Testing

| | CNTs Loading | Tensile | | Percentage | Tensile | | Percentage | Strain | | Percentage |
|---|---|---|---|---|---|---|---|---|---|---|
| | percentage by | Strength | Standard | Changes | Modulus | Standard | Changes | at Break | Standard | Changes |
| | weight (wt %) | (MPa) | Deviation | (%) | (MPa) | Deviation | (%) | (%) | Deviation | (%) |
| Pristine without | 0 | 59.61 | 2.71 | 0.00 | 2688.08 | 63.30 | 0.00 | 2.55 | 0.15 | 0.00 |
| post curing | | | | | | | | | | |
| Pristine | 0 | 64.40 | 1.56 | 8.04 | 2488.21 | 42.69 | −7.44 | 5.04 | 0.38 | 98.08 |
| Post-Cured | | | | | | | | | | |
| Straight | 0.02 | 71.81 | 1.02 | 11.50 | 2361.85 | 31.75 | −5.08 | 5.49 | 0.48 | 8.86 |
| MWCNTs | 0.05 | 67.26 | 0.80 | 4.43 | 2408.79 | 39.30 | −3.19 | 5.81 | 0.10 | 15.19 |
| | 0.08 | 70.44 | 1.57 | 9.38 | 2309.33 | 66.43 | −7.19 | 5.95 | 0.14 | 18.04 |
| | 0.10 | 72.91 | 2.27 | 13.21 | 2466.08 | 40.86 | −0.89 | 6.35 | 0.19 | 25.86 |
| | 0.12 | 71.79 | 1.35 | 11.47 | 2364.17 | 41.74 | −4.99 | 5.97 | 0.11 | 18.36 |
| | 0.15 | 66.84 | 1.16 | 3.78 | 2427.96 | 25.79 | −2.42 | 5.74 | 0.13 | 13.90 |
| | 0.50 | 50.95 | 1.18 | −20.89 | 2480.93 | 50.82 | −0.29 | 2.51 | 0.14 | −50.31 |
| | 1.00 | 42.31 | 1.44 | −34.31 | 2363.26 | 93.47 | −5.02 | 2.10 | 0.18 | −58.40 |
| CNHCs | 0.02 | 67.83 | 1.68 | 5.31 | 2370.10 | 35.96 | −4.75 | 4.70 | 0.42 | −6.74 |
| | 0.05 | 72.75 | 2.04 | 12.96 | 2395.73 | 15.69 | −3.72 | 6.32 | 0.09 | 25.24 |
| | 0.08 | 69.65 | 0.73 | 8.15 | 2319.92 | 44.33 | −6.76 | 5.70 | 0.21 | 13.07 |
| | 0.10 | 70.47 | 2.33 | 9.41 | 2422.47 | 39.59 | −2.64 | 6.18 | 0.14 | 22.61 |
| | 0.12 | 70.64 | 0.42 | 9.68 | 2354.67 | 51.06 | −5.37 | 5.71 | 0.42 | 13.19 |
| | 0.15 | 64.71 | 0.35 | 0.47 | 2462.53 | 27.72 | −1.03 | 5.41 | 0.08 | 7.18 |

The bar-chart in FIG. 15 show that both the CNHCs and MWCNTs nanocomposites show a very similar trend for the improvement of tensile strength. Once the strength value reaches a peak value, it started to decline as the CNTs concentration was increased.

The key difference is that the CNTs reinforcement effects is maximum at different percentages. In the case of MWCNTs, the nanocomposite showed the highest strength values around 0.1 wt % straight CNTs loading, i.e., nearly ˜13% higher than the post cured pristine epoxy samples, making the nanocomposite better in terms of the tensile strength. On the other hand, the CNHCs nanocomposites showed a maximum value at 0.05 wt % of helical CNTs (half the weight percentage compared to straight MWCNTs) and gained ˜13% increase in the strength value. Thus, with lower percentages loading the CNHCs reinforcement exhibit more effective strength improvement compared to the MWCNTs nanocomposites. This can attribute to the fact that CNHCs has better interaction with the epoxy and the helical coil unwinding effects could be anticipated because of their geometrical configuration.

Comparing the modulus results (see FIG. 16), there was a drop in the modulus values. The post curing of the pristine epoxy brought down the modulus value by ˜7%, as compared to the pristine epoxy samples without post curing.

In addition, the introduction of the CNTs decreased the modulus, but no more than 7% loss, which points towards the change in crystallinity of the material. This trend can also be explained by examining the strain at break values (see FIG. 17). When compared on the basis of strain at break the post-cured epoxy showed a superior behavior in terms of ductility and thus the materials modulus decreased by a good margin. And the similar behavior was noted in the nanocomposite samples, i.e., higher ductility and a marginal loss in modulus.

The straight MWCNTs reinforced nanocomposites demonstrated ˜26% increase in strain to failure compared to the post-cured pristine sample at 0.1 wt % CNTs loading, which corresponds to the high tensile strength values for the same CNTs loading (see Table 1). Also, the effects on strain at break was similar to the tensile strength for CNHCs reinforced nanocomposite, which peaked at 0.05 wt % CNTs loading to an impressive ˜25% increase. Both 0.05 wt % CNHCs and 0.1 wt % MWCNTs reinforced nanocomposites showed only minimal changes in tensile modulus, i.e., ˜4% and ˜1% reduction, respectively.

It should be mentioned that the higher percentages of CNTs reinforcement used in this research, mainly the 0.5 wt % and 1 wt % of straight MWCNTs, degraded the properties as compared to the pristine epoxy and the other CNTs reinforced samples. Close observations of the SEM images of the fractured surfaces of both straight MWCNTs and CNHCs reinforced nanocomposites showed more ductile characteristics and fiber pullouts, as compared to the pristine samples (see FIG. 18). One can conclude that the interaction between the CNTs and the epoxy do exist and plays a key role in enhancing the tensile strength and ductility of the nanocomposites.

### Fracture Toughness Test Results

The model plane strain fracture toughness, KIC, measures the resistance of materials to fracture at the presence of a sharp crack. The KIC values of the straight and helical CNTs reinforced nanocomposites and the pristine epoxy samples (with and without post curing) are presented in Table 2. As can be seen, a considerable improvement in fracture toughness was observed for most CNTs reinforced nanocomposites, as compared to the pristine epoxy samples. Because of their very large effective surface area, CNTs interact with epoxy molecules forming network of new bonds throughout the material system. The presence of CNTs in the matrix will delay, blunt and resist the crack growth, thus improving the fracture toughness. The samples will require higher loads and lateral deformations to fracture and in some instances, energy will be dissipated in the form of CNTs pullout, CNTs deformation, and CNTs breakage. The objective of this research was to study the effects of helical geometries of CNHCs at low weight percentage loading on the properties of the polymeric nanocomposites, as compared to straight CNTs reinforced nanocomposites.

Overall, the fracture toughness results obtained for the CNHCs reinforced nanocomposites were considerably higher than those straight MWCNTs reinforced nanocomposites. This can be explained by the unwinding and stretching of the CNHCs during the loading and an increase in the capacity of the samples in energy absorbed by CNHCs before the fracture of specimens. In addition, the presence of CNHCs can blunt the crack tip or deflect the crack to go around the CNHCs creating a longer crack path, resulting in the creation of larger surfaces and thus more energy dissipation. Since the average diameter of these helical carbon nanotubes were 100-200 nm, the surface area required to hold the CNHCs were higher providing a higher resistance to failures caused by CNTs pullout.

TABLE 2
Fracture toughness test results for the post-cured nanocomposite samples
ASTM 5045-Fracture Toughness Testing

| | CNTs | | | |
|---|---|---|---|---|
| | Loading | | | |
| | percentage | KIC | | Percentage |
| | by weight | [MP a · | Standard | Changes |
| | (wt %) | vmm] | Deviation | (%) |
| Pristine without | 0.00 | 27.80 | 0.52 | 0.00 |
| post curing | | | | |
| Pristine Post-cure | 0.00 | 60.61 | 1.12 | 118.02 |
| MWCNTs | 0.02 | 71.49 | 2.57 | 17.96 |
| | 0.05 | 75.94 | 1.87 | 25.29 |
| | 0.08 | 77.11 | 1.11 | 27.23 |
| | 0.10 | 80.68 | 3.13 | 33.11 |
| | 0.12 | 77.37 | 2.22 | 27.66 |
| | 0.15 | 76.89 | 1.21 | 26.87 |
| | 0.50 | 74.10 | 2.15 | 22.26 |
| | 1.00 | 72.70 | 2.42 | 19.96 |
| Helical | 0.02 | 69.53 | 2.69 | 14.72 |
| | 0.05 | 79.34 | 3.41 | 30.91 |
| | 0.08 | 74.69 | 1.07 | 23.24 |
| | 0.10 | 70.02 | 3.88 | 15.53 |
| | 0.12 | 70.54 | 2.15 | 16.39 |
| | 0.15 | 70.71 | 1.42 | 16.67 |

The idea of post curing, as discussed earlier, was to improve the properties of the base epoxy, by using temperatures as high as 121° C., which speeds up the curing process and help to achieve maximum mechanical properties for the base epoxy resin. The post cured pristine epoxy samples showed a ˜118% improvement in fracture toughness values making it more desirable compared to epoxy samples without post curing. It should be mentioned that the inclusion of CNTs increases the fracture toughness and when they are post-cured the effects of post curing will add up with the effects of CNTs inclusion which is very evident in FIG. 19.

The straight MWCNTs reinforced nanocomposite samples with 0.1 wt % loading showed a maximum of ˜33% improvements in fracture toughness compared to the post-cured pristine epoxy samples. The inclusion of straight MWCNTs reinforcements improved the fracture toughness values and it reached its maximum improvement at 0.1 wt % loading of MWCNTs. Form this point forward, the increase in MWCNTs inclusion reduced the improvements and reversed the results. Nevertheless, all the MWCNTs reinforced nanocomposite samples showed an improvement in fracture toughness, compared to the pristine epoxy samples. On the other hand, the CNHCs reinforced nanocomposite samples exhibited a maximum of ˜31% improvement in fracture toughness at 0.05 wt % loading. Similar to the straight MWCNTs reinforced samples, the CNHCs reinforced samples showed an increase in fracture toughness values by increasing the CNHCs loading percentage and reached maximum improvement at 0.05 wt % loading and then gradually decreased for higher percentages loadings.

Overall, the fracture toughness of CNHCs reinforced nanocomposite samples were superior to that of the pristine epoxy samples. Both straight and helical types of CNTs reinforcements showed a similar trend for improving the fracture toughness, except for the peak values that occurred at 0.05 wt % and 0.1 wt % loading for CNHCs and MWCNTs reinforcements, respectively.

The maximum/optimal fracture toughness values for the straight and helical CNTs reinforced nanocomposites were 80.68 and 79.34 MPa·mm1/2, which correspond to 0.1 wt % inclusion of straight CNTs and 0.05 wt % inclusion of CNHCs, respectively. Considering the small difference between these two values and that fact that inclusion of straight CNTs was nearly 100% more than helical CNTs, one can conclude that helical CNTs reinforcement is more effective, especially at low concentrations (i.e., less than 0.2 wt %). FIG. 20 shows SEM images of the fractured surfaces of straight and helical CNTs reinforced nanocomposite samples after fracture toughness testing.

Close examination of the SEM images of fractured surfaces of straight MWCNTs reinforced nanocomposite samples revealed fiber pullout as the predominant failure mechanism (see FIG. 20(a)); whereas, the CNHCs reinforced nanocomposite samples showed both fiber pullout and fiber breakage as the mechanisms of failure (see FIG. 20(b)). The SEM images illustrate the interaction of the CNTs with the epoxy, which acts as a key factor in resisting crack growth and propagation.

### Thermal Conductivity Test Results

The thermal conductivity of the nanocomposites and pristine epoxy samples was tested. Thermal conductivity, of a solid material, is the time rate of steady heat flow through the unit thickness of an infinite slab of a homogeneous material in a direction perpendicular to the surface. This test was performed to find out the influence of CNTs inclusion on the thermal properties of base epoxy. As expected, there was a change in thermal conductivities with variation of the CNTs inclusion in epoxy. The maximum thermal conductivity occurred at 1.0 wt % loading of straight MWCNTs, which was 0.316 W/m° K. It is notable that there is no difference in the thermal conductivity of the post-cured pristine epoxy that was not post cured. This implies that the change in thermal conductivities of the test samples were solely because of the presence of CNTs. It should be mentioned that the thermal conductivity of each sample was measured at different locations to minimize the localized effects.

The results show a steady increase in thermal conductivity with increase in weight percentage of both MWCNTs and CNHCs inclusions. With CNTs having high thermal conductivities, the geometrical shapes of the CNTs do not make a big difference, in this case, but it might make a difference when higher percentages are used. Depending on the applications, in most cases the improvement of thermal conductivity of polymeric resin is desirable for fabrication of high-performance laminated composite structure.

### Dielectric Constant Test Results

The dielectric constant of the nanocomposites and pristine epoxy samples were measured and calculated. Dielectric constant is an electrical property of a material that is a ratio of the permittivity of the material to the permittivity of free space. As the dielectric constant increases, the material degrades its ability to hold the electric charge, in other words, the material readily conducts electricity. So, the significance of the dielectric test was to understand the electrical effect of the epoxy with varying concentrations of electrically conductive CNTs with various geometries.

The results showed that increasing the CNTs loading percentage increases the dielectric constant value and makes the materials more readily conductive. The change in dielectric constants between the MWCNTs and CNHCs reinforced samples was very similar with varying concentrations; hence, it was demonstrated that the addition of both types of CNTs has the same effect on the dielectric property of the epoxy.

### CONCLUSIONS

In this example, the effects of the geometrical shapes and concentration of CNTs on material properties of the polymeric nanocomposites were studied. Compared to post-cured pristine epoxy samples the straight MWCNTs reinforced nanocomposite samples showed ˜13% improvement in tensile strength and ˜26% improvement in strain at break, both at 0.1 wt % loading for post-cured samples. The CNHCs reinforced samples showed an increase of ˜13% and ˜25% for tensile strength and strain at break, respectively, at 0.05 wt % loading of post-cured samples. The main significance of this comparison between straight MWCNTs and CNHCs reinforced nanocomposites was that the CNHCs showed superior influence on the properties at half the weight percentage of the straight MWCNTs. Compared to the post cured pristine epoxy, the nanocomposite made by 0.1 wt % of straight MWCNTs and 0.05 wt % of CNHCs inclusions showed improvement of fracture toughness values by ˜33% and ˜31%, respectively. The CNHCs reinforced nanocomposites showed better fracture toughness at lower weight percentage than MWCNTs nanocomposites.

Thermal conductivity of the nanocomposites showed a positive impact, as the CNTs are thermally very conductive. Both straight MWCNTs and CNHCs inclusions showed a consistent improvement in thermal conductivity with the increase in the weight percentage of the CNTs added. The dielectric constant showed a trend similar to the thermal conductivity results. The more the CNTs were included in epoxy resin, the higher dielectric constants were measured, which was expected since the CNTs are excellent conductors of electricity. To conclude, both straight MWCNTs and CNHCs reinforced nanocomposites showed similar thermal conductivity and Dielectric properties. However, CNHCs inclusions exhibited superior effects on mechanical properties at lower weight percentages making the CNHCs more desirable because of their geometric shapes and their effectiveness in load bearing and distribution.

### Example 3: Chemically Functionalized HCNTs

CNTs were fabricated and functionalized according to Method 1 (reflux in nitric acid) or Method 2 (sonication in sulfuric acid and nitric acid). Various percentage inclusion of the functionalized HCNTs (FHCNTs) in resin systems were investigated. Characterization, inspection, and evaluation of the chemically functionalized HCNTs (i.e., functionalized using the above 72 chemical processes), were performed using various characterization tools/methods. Next, preferred chemical functionalization procedures (i.e., based on the characterization results) for application of HCNTs in high-performance polymeric composites materials were identified, based on the ASTM standard tests. A total of 212 nanocomposite panels were fabricated and tested using the chemically functionalized HCNTs and Epoxy resin. Three different weight percentage of functionalized HCNTs were used to make nanocomposite panels for each functionalization process (i.e., a total of 3×72=212 nanocomposite panels were fabricated).

FIG. 22 shows the schematic and Table 3 shows processing parameters of the Method 1 chemical functionalization of HCNTs 1 that includes reflux with nitric acid, while varying the acid molarity, reflux time, and reflux temperature. A total of 18 various chemical functionalization processes (i.e., sub-methods M101, M102, M103, . . . , M118) were used to chemically functionalize HCNTs. FIGS. 25-26 show the dispersion test results for all chemically functionalized HCNTs produced according to this method after 1 hour, 6 hours, 24 hours, 48 hours, and 1 week.

TABLE 3
Devised Functionalization Methods with Their Related Specific
Parameters for Processes of Method 1: Reflux with Nitric Acid

| | | Molarity | Reflux | Reflux |
|---|---|---|---|---|
| | Oxidant | (M) | Time (hr) | Temperature (° C.) |
| M101 | HNO₃ | 3 | 3 | 60 |
| M102 | HNO₃ | 3 | 3 | 100 |
| M103 | HNO₃ | 3 | 6 | 60 |
| M104 | HNO₃ | 3 | 6 | 100 |
| M105 | HNO₃ | 3 | 24 | 60 |
| M106 | HNO₃ | 3 | 24 | 100 |
| M107 | HNO₃ | 8 | 3 | 60 |
| M108 | HNO₃ | 8 | 3 | 100 |
| M109 | HNO₃ | 8 | 6 | 60 |
| M110 | HNO₃ | 8 | 6 | 100 |
| M111 | HNO₃ | 8 | 24 | 60 |
| M112 | HNO₃ | 8 | 24 | 100 |
| M113 | HNO₃ | 16 | 3 | 60 |
| M114 | HNO₃ | 16 | 3 | 100 |
| M115 | HNO₃ | 16 | 6 | 60 |
| M116 | HNO₃ | 16 | 6 | 100 |
| M117 | HNO₃ | 16 | 24 | 60 |
| M118 | HNO₃ | 16 | 24 | 100 |

FIG. 23 shows the schematic and Table 4 shows processing parameters of the Method 2 chemical functionalization of HCNTs that includes sonication with a mixture of nitric and sulfuric acids, while varying the mixing ratio, acid molarity, and sonication time. A total of 18 various chemical functionalization processes (i.e., sub-methods M201, M202, M203, . . . , M218) were used to chemically functionalize HCNTs. FIGS. 27-28 show the dispersion test results for all chemically functionalized HCNTs produced according to this method after 1 hour, 6 hours, 24 hours, 48 hours, and 1 week.

TABLE 4
Devised Functionalization Methods with Related Specific Parameters for
Processes of Method 2: Sonication with Nitric and Sulfuric Acids

| | Oxidant | Oxidant | | Molarity | Sonication |
|---|---|---|---|---|---|
| | 1 | 2 | Ratio | (M) | Time (hr) |
| M201 | H₂SO₄ | HNO₃ | 1:1 | 3 | 3 |
| M202 | H₂SO₄ | HNO₃ | 1:1 | 3 | 6 |
| M203 | H₂SO₄ | HNO₃ | 1:1 | 3 | 9 |
| M204 | H₂SO₄ | HNO₃ | 1:1 | 8 | 3 |
| M205 | H₂SO₄ | HNO₃ | 1:1 | 8 | 6 |
| M206 | H₂SO₄ | HNO₃ | 1:1 | 8 | 9 |
| M207 | H₂SO₄ | HNO₃ | 1:1 | 16 | 3 |
| M208 | H₂SO₄ | HNO₃ | 1:1 | 16 | 6 |
| M209 | H₂SO₄ | HNO₃ | 1:1 | 16 | 9 |
| M210 | H₂SO₄ | HNO₃ | 3:1 | 3 | 3 |
| M211 | H₂SO₄ | HNO₃ | 3:1 | 3 | 6 |
| M212 | H₂SO₄ | HNO₃ | 3:1 | 3 | 9 |
| M213 | H₂SO₄ | HNO₃ | 3:1 | 8 | 3 |
| M214 | H₂SO₄ | HNO₃ | 3:1 | 8 | 6 |
| M215 | H₂SO₄ | HNO₃ | 3:1 | 8 | 9 |
| M216 | H₂SO₄ | HNO₃ | 3:1 | 16 | 3 |
| M217 | H₂SO₄ | HNO₃ | 3:1 | 16 | 6 |
| M218 | H₂SO₄ | HNO₃ | 3:1 | 16 | 9 |

FIG. 24 shows the schematic and Table 5 shows processing parameters of the Method 3 chemical functionalization of HCNTs that includes reflux with a mixture of nitric and sulfuric acids, while varying the mixing ratio, acid molarity, reflux time, and reflux temperature. A total of 36 various chemical functionalization processes (i.e., sub-methods M301, M302, M303, . . . , M336) were used to chemically functionalize HCNTs. FIGS. 29-30 show the dispersion test results for all chemically functionalized HCNTs produced according to this method after 1 hour, 6 hours, 24 hours, 48 hours, and 1 week. FIG. 3I shows an example scanning electron micrograph of the FHCNTs that were functionalized using one of the sub-methods of Method 3.

TABLE 5
Devised Functionalization Methods with Their Related
Specific Parameters for Processes of Method 3:
Reflux with Nitric and Sulfuric Acids

| | | | | Mo- | Reflux | Reflux |
|---|---|---|---|---|---|---|
| | | | | larity | Time | Temperature |
| | Oxidant 1 | Oxidant 2 | Ratio | (M) | (hr) | (° C.) |
| M301 | H₂SO₄ | HNO₃ | 1:1 | 3 | 3 | 60 |
| M302 | H₂SO₄ | HNO₃ | 1:1 | 3 | 3 | 100 |
| M303 | H₂SO₄ | HNO₃ | 1:1 | 3 | 6 | 60 |
| M304 | H₂SO₄ | HNO₃ | 1:1 | 3 | 6 | 100 |
| M305 | H₂SO₄ | HNO₃ | 1:1 | 3 | 24 | 60 |
| M306 | H₂SO₄ | HNO₃ | 1:1 | 3 | 24 | 100 |
| M307 | H₂SO₄ | HNO₃ | 1:1 | 8 | 3 | 60 |
| M308 | H₂SO₄ | HNO₃ | 1:1 | 8 | 3 | 100 |
| M309 | H₂SO₄ | HNO₃ | 1:1 | 8 | 6 | 60 |
| M310 | H₂SO₄ | HNO₃ | 1:1 | 8 | 6 | 100 |
| M311 | H₂SO₄ | HNO₃ | 1:1 | 8 | 24 | 60 |
| M312 | H₂SO₄ | HNO₃ | 1:1 | 8 | 24 | 100 |
| M313 | H₂SO₄ | HNO₃ | 1:1 | 16 | 3 | 60 |
| M314 | H₂SO₄ | HNO₃ | 1:1 | 16 | 3 | 100 |
| M315 | H₂SO₄ | HNO₃ | 1:1 | 16 | 6 | 60 |
| M316 | H₂SO₄ | HNO₃ | 1:1 | 16 | 6 | 100 |
| M317 | H₂SO₄ | HNO₃ | 1:1 | 16 | 24 | 60 |
| M318 | H₂SO₄ | HNO₃ | 1:1 | 16 | 24 | 100 |
| M319 | H₂SO₄ | HNO₃ | 3:1 | 3 | 3 | 60 |
| M320 | H₂SO₄ | HNO₃ | 3:1 | 3 | 3 | 100 |
| M321 | H₂SO₄ | HNO₃ | 3:1 | 3 | 6 | 60 |
| M322 | H₂SO₄ | HNO₃ | 3:1 | 3 | 6 | 100 |
| M323 | H₂SO₄ | HNO₃ | 3:1 | 3 | 24 | 60 |
| M324 | H₂SO₄ | HNO₃ | 3:1 | 3 | 24 | 100 |
| M325 | H₂SO₄ | HNO₃ | 3:1 | 8 | 3 | 60 |
| M326 | H₂SO₄ | HNO₃ | 3:1 | 8 | 3 | 100 |
| M327 | H₂SO₄ | HNO₃ | 3:1 | 8 | 6 | 60 |
| M328 | H₂SO₄ | HNO₃ | 3:1 | 8 | 6 | 100 |
| M329 | H₂SO₄ | HNO₃ | 3:1 | 8 | 24 | 60 |
| M330 | H₂SO₄ | HNO₃ | 3:1 | 8 | 24 | 100 |
| M331 | H₂SO₄ | HNO₃ | 3:1 | 16 | 3 | 60 |
| M332 | H₂SO₄ | HNO₃ | 3:1 | 16 | 3 | 100 |
| M333 | H₂SO₄ | HNO₃ | 3:1 | 16 | 6 | 60 |
| M334 | H₂SO₄ | HNO₃ | 3:1 | 16 | 6 | 100 |
| M335 | H₂SO₄ | HNO₃ | 3:1 | 16 | 24 | 60 |
| M336 | H₂SO₄ | HNO₃ | 3:1 | 16 | 24 | 100 |

As can be seen, most chemically functionalized HCNTs demonstrated a higher solubility compared to the untreated pristine HCNTs. However, few of treated HCNTs had clear sedimentation after one week. Generally, results from the dispersion test showed that all processes increased the solubility of HCNTs drastically.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described herein as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described herein should not be understood as requiring such separation in all embodiments, and it should be understood that the described program components and systems can generally be integrated together in a single product or packaged into multiple products.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A nanocomposite structure comprising:
a first microfiber;
a second microfiber; and
a plurality of nanostructures coupling the first and second microfibers together, wherein the plurality of nanostructures comprise helical tubes.

2. The nanocomposite structure of claim 1, wherein plurality of nanostructures comprises chemically functionalized nanostructures.

3. The nanocomposite structure of claim 1, wherein the helical tubes are selected from the group consisting of helical carbon tubes, chemically functionalized helical carbon tubes, and combinations thereof.

4. The nanocomposite structure of claim 1, wherein at least a portion of the plurality of nanostructures couple with the first fiber and adjacent nanostructures.

5. The nanocomposite structure of claim 1, wherein the nanostructures are selected from the group consisting of carbon, boron nitride, silicon, silicon carbide, silver-gallium, platinum, silver, metal oxides, and combinations thereof.

6. The nanocomposite structure of claim 1, wherein the nanostructures comprise carbon.

7. The nanocomposite structure of claim 1, wherein the first microfiber, the second microfiber, or both, are selected from the group consisting of glass, a para-aramid synthetic fiber, carbon, silicon carbide, boron, aluminum oxide, or combinations thereof.

8. The nanocomposite structure of claim 1, wherein the nanostructures have an elongate body with a length of greater than 2 microns.

9. The nanocomposite structure of claim 8, wherein the nanostructures have an elongate body with a length ranging from about 10 microns to about 50 microns, from about 50 microns to about 100 microns, from about 100 microns to about 500 microns, from about 500 microns to about 1000 microns, or from about 1000 microns to about 10000 microns.

10. The nanocomposite structure of claim 1, wherein an amount of nanostructures ranges from about 0.02% to about 1% by weight of the nanocomposite.

11. The nanocomposite structure of claim 1, wherein an amount of the nanostructures is less than 1% by weight of the nanocomposite.

12. The nanocomposite structure of claim 11, wherein an amount of the nanostructures is less than 0.5% by weight of the nanocomposite.

13. The nanocomposite structure of claim 12, wherein an amount of the nanostructures is less than 0.2% by weight of the nanocomposite.

14. The nanocomposite structure of claim 1, wherein an amount of microstructures ranges from about 10% to about 70 by weight of the nanocomposite.

15. The nanocomposite structure of claim 1, further comprising a resin matrix in which the first microfiber, the second microfiber, and the plurality of nanostructures are embedded uniformly therein.

16. The nanocomposite structure of claim 15, wherein the resin matrix comprises an epoxy polymer.

17. The nanocomposite structure of claim 1, wherein the first and second microfibers are comprised within a bundle, tow, or yarn of microfibers that are coupled together by the plurality of nanostructures within the nanocomposite structure.

18. The nanocomposite structure of claim 1, wherein each helical tube has a tube diameter of about 1 nm to about 100 nm.

19. The nanocomposite structure of claim 1, wherein each helical nanostructure has a coil diameter of about 50 nm to about 500 nm, from about 100 nm to about 300 nm, or from about 200 to about 300 nm.

20. The nanocomposite structure of claim 1, wherein the nanocomposite structure comprises a plurality of microfibers.

21. A method of forming the nanocomposite structure of claim 1, the method comprising using a chemical vapor deposition system to vaporize a precursor-catalyst solution to form nanostructures on a substrate, wherein the nanostructures are helical carbon nanotubes, and wherein the substrate comprises a glass fiber foam including a plurality of randomly oriented glass fibers.
